(19) United States
(12) Patent Application Publication
(10) Pub. No.: US 2019/0359507 A1
(43) Pub. Date: Nov. 28, 2019

(54) FLUID FILTRATION SYSTEMS AND METHODS

(71) Applicant: Green Age Technologies LLC, Tyler, TX (US)

(72) Inventors: Fred Stuckey, Tyler, TX (US); Martin Margulies, Pagosa Springs, CO (US)

(73) Assignee: Green Age Technologies LLC, Tyler, TX (US)

(21) Appl. No.: 16/461,762

(22) PCT Filed: Nov. 16, 2017
(86) PCT No.: PCT/US2017/062012

§ 371 Date: May 16, 2019

Related U.S. Application Data
(60) Provisional application No. 62/423,037, filed on Nov. 16, 2016.

(51) Int. Cl. C02F 1/48; C02F 1/00; C02F 1/36; C02F 1/44

(52) U.S. Cl. CPC C02F 1/48; C02F 1/004; C02F 2103/10; C02F 1/44; C02F 1/36

(57) ABSTRACT

A system for filtering fluid that includes a start tank, a finish tank, and a polisher. The polisher includes an inlet, a first outlet fluidly coupled to the finish tank, a second outlet fluidly coupled to the start tank, a filter unit, and one or more transducer coupled to an outer surface of the polisher. The one or more transducers to induce at least one of an electric field or a magnetic field across the filter unit. The start tank is fluidly coupled to the inlet of the polisher.

### CROSS-REFERENCE TO RELATED APPLICATION

The present application claims benefit of U.S. provisional patent application No. 62/423,037 filed Nov. 16, 2016, and entitled “Fluid Filtration Systems and Methods,” which is hereby incorporated herein by reference in its entirety.

### STATEMENT REGARDING FEDERALLY SPONSORED RESEARCH OR DEVELOPMENT

Not applicable.

### BACKGROUND

The present disclosure relates to filtration or filtering systems for fluids. More particularly, the disclosure relates to a filtering system to remove particulate matter from a fluid. The filtering system is configured to remove solid particles from the fluids such that the fluids can then be recycled.

In modem industrial practice, it is common to filter fluids (e.g., liquids) in order to prepare such fluids for use, reuse, and/or introduction into the natural environment. For example, water used and produced in oil and gas well fracturing (or stimulation) operations requires treatment or processing before re-use and disposal. The water is treated to remove chemicals that were added to the water before use and/or chemicals and sediment suspended in the water after use as a by-product of the well stimulation. The water, commonly referred to as used flowback fracturing (“frac”) water and produced water, may have been processed to ensure that it is capable of being used initially for stimulating oil and gas wells and is again processed for that purpose. Without appropriate treatment, contaminants or other suspended particulate matter entering the frac water can cause formation damage, plugging, lost production, and increased demand for chemical treatment additives. In addition, the water is processed for disposal, for example, to prevent contamination of ground water resources.

Because the filtered fluids and the suspended contaminants and particulates can vary widely depending on the specific application, it is advantageous for a filtering system (or systems) to be configured to receive and filter various fluids, and to be adaptable or adjustable to filter such fluids using a single system.

### BRIEF DESCRIPTION OF THE DRAWINGS

For a detailed description of exemplary embodiments of the disclosure, reference will now be made to the accompanying drawings in which:

FIG. 1 is a schematic, partial cross-sectional view of an embodiment of a filter system in accordance with at least some embodiments disclosed herein;

FIG. 2 is a schematic, partial cross-sectional view of an embodiment of the filter assembly of the filter system of FIG. 1;

FIG. 3 is a side view of an alternative embodiment of the filter assembly of the filter system of FIG. 1;

FIG. 4 is an enlarged schematic, cross-sectional view of the filter screen of the filter assembly of FIG. 2 taken along detail section 4 in FIG. 2;

FIG. 5 is an enlarged schematic cross-sectional view of an alternative embodiment of the filter screen of the filter assembly of FIG. 2;

FIG. 6 is a perspective view of one of the media vortex generator cups of the filter assembly of FIG. 2;

FIG. 7 is a schematic, partial cross-sectional view of an alternative embodiment of the filter assembly of the filter system of FIG. 1;

FIG. 8 is a schematic, cross-sectional view of a solids collector of the filter system of FIG. 1;

FIG. 9 is a schematic side view of the polisher of the filter system of FIG. 1;

FIG. 10 is a schematic side cross-sectional view of the polisher of FIG. 9;

FIG. 11 is a schematic top view of the polisher of FIG. 9, showing the sonic and electromagnetic waves emitted from a plurality of transducers;

FIG. 12 is a side view of a diffuser for use within the polisher of FIG. 9;

FIG. 13 is a cross-sectional view taken along section 13-13 in FIG. 12;

FIG. 14 is a cross-sectional view taken along section 14-14 in FIG. 10;

FIG. 15 is a schematic perspective view of one of the filter membrane assemblies of the filter unit within the polisher of FIG. 9;

FIG. 16 is a schematic, partial cross-sectional view of the filter system of FIG. 1 during filtration operations;

FIG. 17 is a schematic, partial cross-sectional view of the filter system of FIG. 1 operating in a reject state;

FIG. 18 is an enlarged schematic, cross-sectional view of the filter screen of the filter assembly of FIG. 4 with micro-holes formed on the radially inner surface thereof;

FIG. 19 is a schematic, partial cross-sectional view of another embodiment of a filter system in accordance with at least some of the embodiments disclosed herein;

FIG. 20 is a schematic, partial cross-sectional view of the filter system of FIG. 18 operating in a reject state;

FIG. 21 is a schematic, partial cross-sectional view of another embodiment of a filter system in accordance with at least some embodiments disclosed herein;

FIG. 22 shows a block diagram of an embodiment of a method of filtering fluids in accordance with at least some embodiments disclosed herein;

FIG. 23 shows a block diagram of an embodiment of another method of filtering fluids in accordance with at least some embodiments disclosed herein; and

FIG. 24 shows a block diagram of another embodiment of a method of filtering fluids in accordance with at least some embodiments disclosed herein.

### DETAILED DESCRIPTION

Certain terms are used throughout the following description and claims to refer to particular system components. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct mechanical connection, or an indirect, direct, optical or wireless electrical connection. Thus, if a first device couples to a second device, that connection may be through a direct mechanical or electrical connection, through an indirect mechanical or electrical connection via other devices and connections, through an optical electrical connection, or through a wireless electrical connection. In addition, as used herein the terms “axial” and “axially” generally mean along or parallel to a central axis (e.g., central axis of a body or port), while the terms “radial” and “radially” generally mean perpendicular to the central axis. For instance, an axial distance refers to a distance measured along or parallel to the central axis, and a radial distance means a distance measured perpendicular to the central axis. Further, the term “software” includes any executable code capable of running on a processor, regardless of the media used to store the software. Thus, code stored in memory (e.g., non-volatile memory), and sometimes referred to as “embedded firmware,” is included within the definition of software. Still further, as one having ordinary skill will understand and appreciate, as used herein, the term “fluid” expressly includes both liquids, gases, and mixed phase flows (i.e., flows containing both liquid and gas components).

In the following description and figures, embodiments of a filter system are described for filtering both suspended and dissolved impurities from flowback frac water. However, it should be appreciated that embodiments of the filter system described herein and methods relating thereto may be utilized in a wide variety of systems and applications which employ such systems to filter suspended and dissolved solids from a liquid (e.g., water). For example, embodiments of the filtering system described herein may be used to filter both suspended and dissolved particulates (e.g., sodium chloride) from sea water and/or suspended and dissolved particulates and contaminants from fluids produced from subterranean mines (e.g., subterranean mineral mines). Therefore, filtering of flowback frac water is merely one of many potential uses of the filtering system and methods described herein. Thus, any reference to flowback frac water (or any other fluid) and related subject matter is merely included to provide context to the description contained herein and is in no way meant to limit the scope thereof. At various times, the word “filter” may also be interchanged with words such as “filtering” or “filtration,” though no difference in meaning is intended unless otherwise noted.

The following discussion is directed to various embodiments of the disclosure. Although one or more of these embodiments may be preferred, the embodiments disclosed should not be interpreted, or otherwise used, as limiting the scope of the disclosure, including the claims. In addition, one having ordinary skill in the art will understand that the following description has broad application, and the discussion of any embodiment is meant only to be exemplary of that embodiment, and not intended to intimate that the scope of the disclosure, including the claims, is limited to that embodiment.

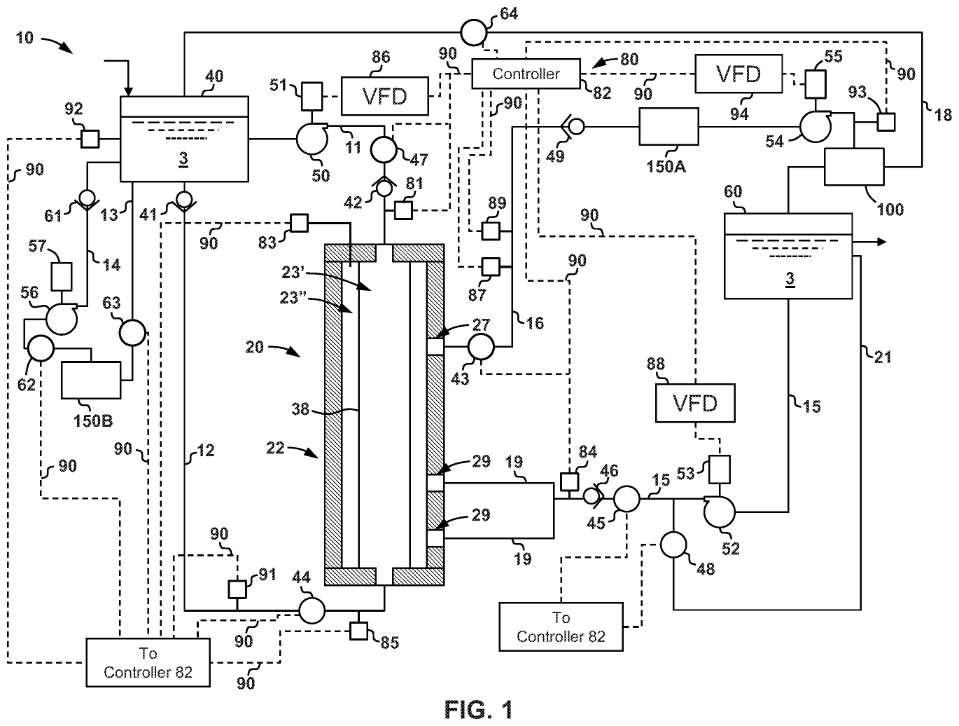

Referring to FIG. 1, an embodiment of a filter system 10 is shown. The filter system 10 generally comprises a filter assembly 20, a start or dirty tank 40, a finish or clean tank 60, a first or feed pump 50, a second or reversing pump 52, a third or delta pump 54, a fourth or reject pump 56, and a control system 80. In addition, filter system 10 includes a polisher 100, and a first solids collector 150A, and a second solids collector 150B.

Each of the components (e.g., tanks 40, 60, assemblies 20, solids collectors, 150A, 150B, polisher 100, pumps 50, 52, 54, 56) of system 10 are fluidly coupled together through a plurality of conduits 11, 12, 13, 14, 15, 16, 17, 18, 19, 21. In particular, system 10 includes a feed line 11, a flush line 12, a discharge line 16, a return line 15, a recirculation line 21, a pair of injection lines 19, a tank solids rejection line 13, a tank return line 14, a polisher clean water outlet line 17, and a polisher return line 18. Each of the lines 11, 12, 13, 14, 15, 16, 17, 18, 19, 21 comprises any suitable conduit capable of channeling fluids therethrough. For example, lines 11, 12, 13, 14, 15, 16, 17, 18, 19, 21 may comprise pipes, hoses, open water channels, or other fluid conveyances.

Further, system 10 also includes a plurality of valves disposed at various locations along lines 11, 12, 13, 14, 15, 16, 17, 18, 19, 21 to control the flow of fluids through system 10 during operation. In particular, a check valve 42 is disposed along feed line 11 and is configured to restrict fluid flow from assembly 20 toward feed pump 50. An actuatable valve 47 is also disposed along feed line 11 to selectively control fluid communication between tank 40 and assembly 20 along line 11. In addition, a check valve 41 is disposed along flush line 12 and is configured to restrict fluid flow from tank 40 toward assembly 20 along line 12. An actuatable valve 44 is also disposed along flush line 12 to selectively control fluid flow between assembly 20 and tank 40 along line 12. A check valve 49 is disposed along discharge line 16 and is configured to restrict fluid flow from tank 60 toward assembly 20. An actuatable valve 45 is also disposed along the discharge line 16 to selectively control fluid communication between assembly 20 and solids collector 150B, pump 54, and polisher 100 along line 16. A check valve 46 is disposed along return line 15 and is configured to restrict fluid flow from injection lines 19 toward reversing pump 52. An actuatable valve 43 is also disposed along line 15 to selectively control fluid flow between pump 52 and assembly 20 along lines 15, 19. An actuatable valve 48 is disposed along recirculation line 21 to selectively control fluid flow between pump 52 and tank 60 along line 21. A check valve 61 is disposed along tank return line 14 and is configured to restrict fluid flow from start tank 40 toward reject pump 56. An actuatable valve 62 is disposed along return line 14 and is configured to selectively control fluid flow between second solids collector 150B and pump 56. An actuatable valve 63 is disposed along tank solids rejection line 13 and is configured to selectively control flow of fluid between start tank 40 and solids collector 150B. An actuatable valve 64 is disposed along polisher return line 18 and is configured to selectively control fluid flow between polisher 100 and start tank 40.

Each of the check valves 41, 42, 46, 49, 61 may be any suitable valve which allows fluid flow in only one direction. For example, in some embodiments, check valves 41, 42, 46, 49, 61 may comprise a swing check valve, spring check valve, inline check valve, ball cone check valve, or some combination thereof. In addition, check valves 41, 42, 46, 49, 61 may comprise any suitable material and, in some embodiments, preferably comprise a corrosion resistant material. For example in some embodiments, check valves 41, 42, 46, 49, 61 comprise stainless steel or brass. Also, the selectively actuatable valves 43, 44, 45, 47, 48, 62, 63, 64 may be any suitable valve for controlling the flow of fluids along a conduit (e.g., lines 11, 12, 13, 14, 15, 16, 17, 18, 19, and 21). For example, in some embodiments, the actuatable valves 43, 44, 45, 47, 48, 62, 63, 64 may comprise electro-magnetic valves, electro-hydraulic valves, electro-mechanical valves, or some combination thereof. Further, in some embodiments, each of the actuatable valves 43, 44, 45, 47, 48, 62, 63, 64 may comprise a pinch valve, ball valve, gate valve, knife valve, pneumatic valve, hydraulic valve, electronic solenoid valve, or some combination thereof. Still further, in some embodiments, actuatable valves 43, 44, 45, 47, 48, 62, 63, 64 may comprise any suitable material and, in some embodiments, preferably comprise a corrosion resistant material. For example, in some embodiments, actuatable valves 43, 44, 45, 47, 48, 62, 63, 64 comprise stainless steel or brass.

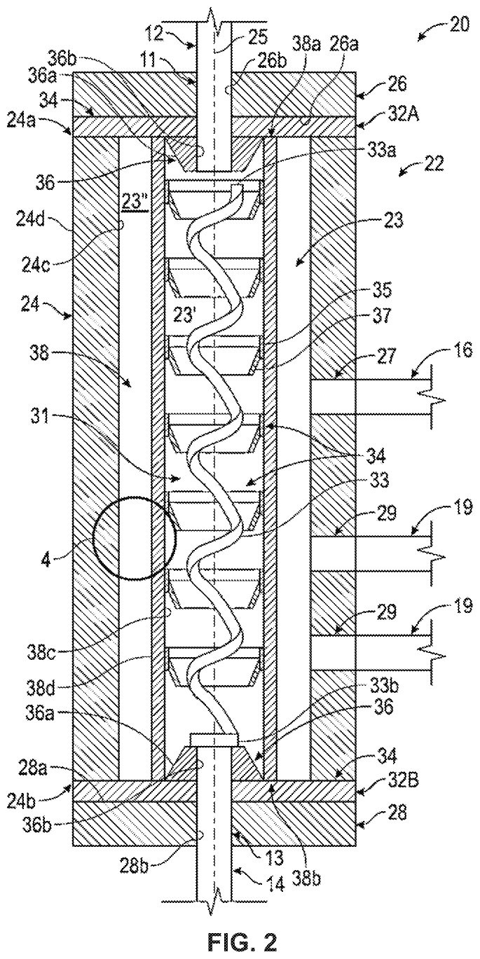

Referring now to FIG. 2, in this embodiment, filter assembly 20 may be substantially the same as the filter assembly described in U.S. Pat. No. 9,115,013, the entire contents of which are incorporated herein by reference in their entirety for all purposes. Specifically, in this embodiment, the filter assembly 20 includes a pressure housing or vessel 22, and a filter member or screen 38. Vessel 22 generally includes an elongate tubular body 24, having a central, longitudinal axis 25, a first or upper end 24a, a second or lower end 24b opposite the upper end 24a, a radially inner surface 24c extending axially between the ends 24a, 24b, and a radially outer surface 24d extending axially between the ends 24a, 24b. In this embodiment, a main clean water outlet 27 is axially disposed between the ends 24a, 24b and extends radially between the surfaces 24c, 24d, while a pair of return inlets 29 are axially disposed between the clean water outlet 27 and the lower end 24b and each also extends radially between the surfaces 24c, 24d. Clean water outlet 27 is coupled to discharge line 16, while return inlets 29 are each coupled to one of the injection lines 19, previously described. It should be appreciated that in other embodiments the specific locations of the inlets 27 and outlets 29 may be altered and varied.

In this embodiment, vessel 22 also includes a first or upper intermediate cap 32A axially disposed at upper end 24a of body 24 and a second or lower intermediate cap 32B axially disposed at lower end 24b. Each intermediate cap 32A, 32B is generally configured the same and includes a first or coupling portion 34 and a second or funnel portion 36. Coupling portion 34 is generally cylindrical in shape and is configured to engage with body 24 during construction of assembly 20. Funnel portion 36 of each intermediate cap 32A, 32B generally extends axially from the coupling portion 34 and includes an outer frustoconical surface 36a and a throughbore 36b. Further, vessel 22 includes a first or upper cap 26 including a sealing surface 26a and a throughbore 26b, and a second or lower cap 28 including a sealing surface 28a and throughbore 28b.

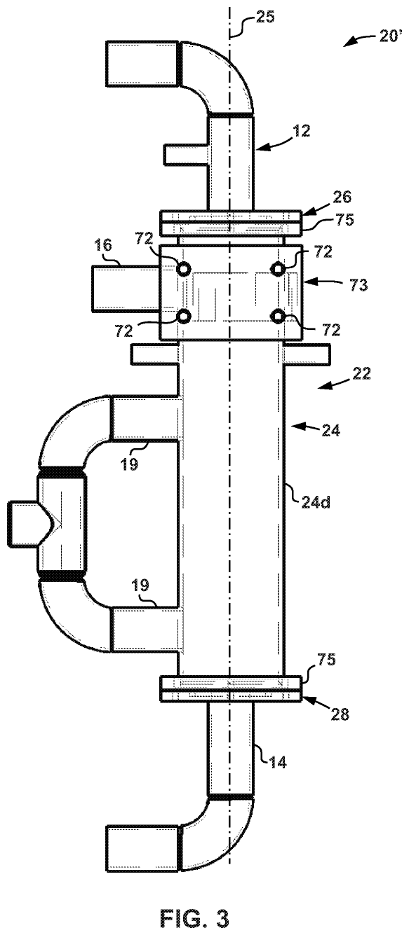

It should be appreciated that in some embodiments, intermediate caps 32A, 32B are removed from vessel 22. For example, referring briefly to FIG. 3, wherein an alternative embodiment of filter assembly 20 (designated as assembly 20′) is shown. Filter assembly 20′ includes many similar components relative to the filter assembly 20. As a result, like reference numerals are used for like components and features, and shared components may not be called out or discussed in detail with reference to FIG. 3, but the same description with regard to FIG. 2 applies equally to the assembly 20′ of FIG. 3 unless otherwise noted. Instead, the focus of the discussion will be on variations or differences in the filter assembly 20′ over the filter system 20. For example, in assembly 20′, intermediate caps 32A, 32B are not disposed between caps 26, 28 and body 24 of vessel 22 and caps 26, 28 each directly couple to body 24 through a pair of mating flanges 75. In addition, the embodiment of assembly 20′ shown in FIG. 3 also includes a mounting plate 73 which further includes a plurality of mounting apertures or holes 72. During assembly operations, plate 73 is used to fix or mount assembly 20′ to a surface or particular position by aligning holes 72 with corresponding holes on a mounting surface (not shown) and then engaging a securing member (e.g., screw, nail, bolt, rivet) through each of the holes 72 (and the aligned holes on the mounting surface). However, it should be appreciated that in some embodiments, any other suitable mounting device or assembly (other than plate 73) may be used. Additionally, in some embodiments, no mounting assembly or device is included.

Referring back now to FIG. 2, during assembly of filter assembly 20, intermediate caps 32A, 32B are axially disposed between caps 26, 28 such that coupling portion 34 of intermediate cap 32A is axially disposed between sealing surface 26a of cap 26 and upper end 24 of body, and coupling section 34 of cap 28 is axially disposed between sealing surface 28a of cap 28 and lower end 24b of body 24. Body 24, intermediate caps 32A, 32B, and caps 26, 28 may be secured to one another through any suitable method. For example, in some embodiments, body 24, intermediate caps 32A, 32B, and caps 26, 28 may be secured to one another with bolts, rivets, welding, sintering, or some combination thereof.

When the caps 26, 28 and intermediate caps 32A, 32B are coupled to the ends 24a, 24b of body 24, respectively, a sealed inner pressure chamber 23 is formed that is defined by the surface 24c and intermediate caps 32A, 32B. As will be described in more detail below, chamber 23 receives fluid (e.g., used flowback frac water, water produced from a subterranean mineral mine, salt water) from start tank 40 during operations in order to facilitate cleaning and filtering thereof. In some embodiments, chamber 23 may have a maximum allowable pressure of 450 psi, and an operating pressure of less than 100 psi; however, it should be appreciated that in other embodiments, the maximum allowable and operating pressures may vary. In addition, during construction of assembly 20, the throughbore 36b of upper intermediate cap 32A and the throughbore 26b of upper cap 26 are each coaxially aligned along axis 25 to form a main dirty water inlet 7 into chamber 23. The throughbore 38b of lower intermediate cap 32B and the throughbore 28b of lower cap 28 are also coaxially aligned along axis 25 to form a flush fluid outlet 9 from chamber 23. In this embodiment, inlet 7 is coupled to feed line 11, while flush fluid outlet 9 is coupled to flush line 12. Further, in some embodiments, many features of a filter assembly 20 (e.g., vessel 22, caps 26, 28, and intermediate caps 32A, 32B) comprise stainless steel; however, in other embodiments, the features of assembly 20 may comprise various other materials such as, for example, carbon fiber, or steel alloys.

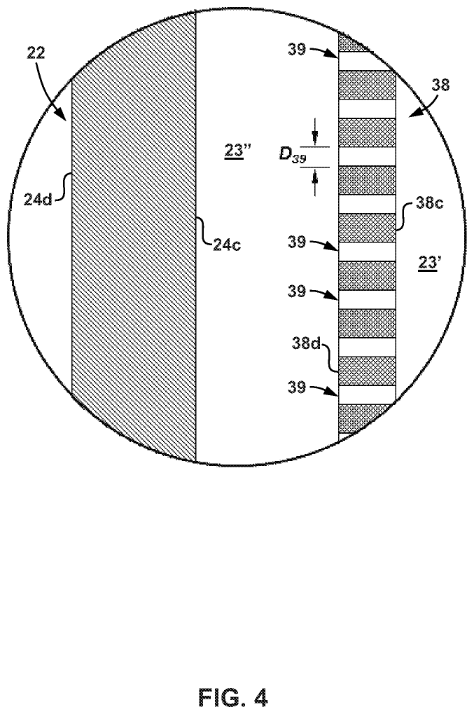

Referring now to FIGS. 2 and 4, a tubular filter member or screen 38 is disposed within chamber 23 and is coaxially aligned with the axis 25. In this embodiment, screen 38 is a substantially cylindrical tube that includes a first or upper end 38a, a second or lower 38b opposite the upper end 38a, a radially inner surface 38c extending between the ends 38a, 38b, and a radially outer surface 38d also extending between the ends 38a, 38b. As is best shown in FIG. 4, a plurality of apertures or holes 39 extend generally radially between the surfaces 38c, 38d and are disposed axially between the ends 38a, 38b. Holes 39 may be formed of any shape or cross-section while still complying with the principles disclosed herein. For example, in some embodiments, holes 39 may be circular, elliptical, polygonal, triangular, or diamond shaped. Further, regardless of the shape of holes 39, each hole 39 has a maximum diameter or clearance D₃₉, which thus defines the maximum particle size which hole 39 will allow to pass therethrough. In some embodiments, diameter D₃₉ may range from 1 to 100 μm depending on the type of fluids to be filtered by assembly 20. In some embodiments, screen 38 comprises a sintered wire mesh or a sintered “Dutch Twill” and may further include a lattice structure to withstand operating pressures within chamber 23. Also, in some embodiments, screen 38 comprises stainless steel, although any suitable material may be used, such as, for example, carbon fiber, a ceramic, a synthetic material, or some combination thereof.

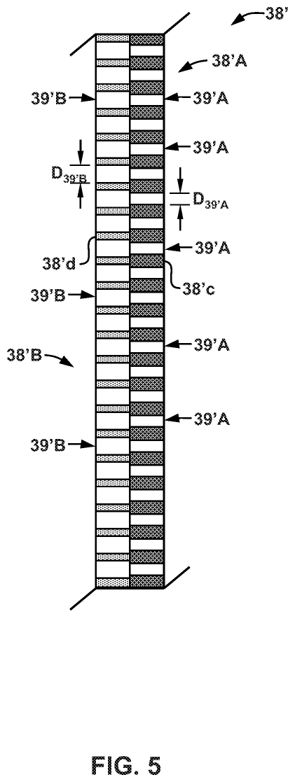

Reference is now made to FIG. 5, wherein an alternative embodiment of screen 38′ is shown. As with screen 38, previously described, screen 38′ is a substantially cylindrical tube that includes a radially inner surface 38′c and a radially outer surface 38′d . In addition, screen 38′ comprises multiple radially stacked layers that are sintered or otherwise engaged to one another. For example, in this embodiment, screen 38′ comprises a first or inner layer 38′A and a second or outer layer 38′B; however, it should be appreciated that in other embodiments, more than two layers (e.g., layers 38′A, 38′B) may be included. In this embodiment, inner layer 38′A includes a plurality of apertures or holes 39′A extending radially from the surface 38′c to the outer layer 38′B, while the outer layer 38′B includes a plurality of apertures or holes 39′B extending radially from the inner layer 38′A to the radially outer surface 38′d. As previously described for holes 39 of screen 38, each hole 39′A, 39′B may comprise any shape while still complying with the principles disclosed herein. For example, in some embodiments, holes 39′A, 39′B may be circular, elliptical, polygonal, triangular, or diamond shaped. Further, each hole 39′A has a maximum diameter or clearance D_{39′A} and each hole 39′B has a maximum diameter or clearance D_{39′B}. Each of the diameters D_{39′A}, D_{39′B} may range from 1 to 100 μm, and in this embodiment, the diameter D_{39′B} is larger than the diameter D_{39′A}. However, it should be appreciated that in other embodiments, the relative sizing of diameters D_{39′A}, D_{39′B} may vary greatly. For example, in some embodiments, the diameter D_{39′A} is larger than the diameter D_{39′B} while in other embodiments, the diameters D_{39′A}, D_{39′B} are substantially the same. As previously described above for screen 38, in some embodiments layers 38′A, 38′B of screen 38′ may each comprise a sintered wire mesh or a sintered “Dutch Twill” and may further include a lattice structure to withstand operating pressures within chamber 23. Also, in some embodiments, screen 38′ comprises stainless steel, although any suitable material may be used, such as, for example, carbon fiber, a ceramic, a synthetic material, or some combination thereof.

Referring back to FIG. 2, screen 38 (or screen 38′ in some embodiments) is disposed within chamber 23 such that upper end 38a engages or abuts upper intermediate cap 32A and lower end 38b engages or abuts lower intermediate cap 32B. For embodiments that do not include intermediate caps 32A, 32B (e.g., assembly 20′ shown in FIG. 3) ends 38a, 38b of screen 38 may directly engage sealing surfaces 26a, 28a of end caps 26, 28, respectively. Therefore, when screen 38 is installed within vessel 22, chamber 23 is divided into a first or inner subchamber 23′ and a second or outer subchamber 23″. In some embodiments, screen 38 is merely placed within chamber 23; however, it should be appreciated that in other embodiments, screen 38 is secured within chamber 23 during construction of assembly 20. In these embodiments, screen 38 may be secured to the intermediate caps 32A, 32B and/or the caps 26, 28 by any suitable method, such as, for example bolts, rivets, welding, sintering, or some combination thereof.

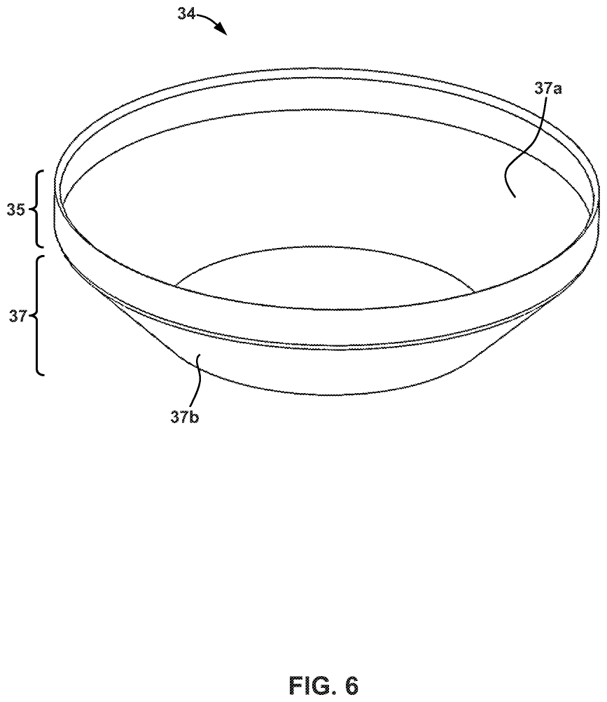

Referring still to FIG. 2, in some embodiments, assembly 20 further includes a spiral vortex generator 31 and/or a plurality of vortex generating cups 34. Spiral vortex generator 31 comprises a generally helically shaped body 33 that includes a first or upper end 33a and a second or lower end 33b opposite the upper end 33a. Vortex generator 31 is disposed within inner subchamber 23′ of chamber 23 such that the lower end 33b is seated on funnel section 36 of lower intermediate cap 32B and generator 31 is substantially coaxially aligned with axis 25. Vortex generating cups 34 are funnel-like structures that are disposed along the radially inner surface 38c of screen 38. In particular, referring briefly to FIG. 6, each cup 34 includes a coupling section 35 and a baffle 37. Coupling section 35 comprises a cylindrical band while baffle 37 extends from section 35 and includes a frustoconical outer surface 37a and a frustoconical inner surface 37b. In some embodiments, section 35 and baffle 37 are monolithically formed; however, it should be appreciated that in other embodiments, section 35 and baffle 37 are not monolithically formed. As is best shown in FIG. 2, cups 34 are disposed within inner subchamber 23′ such that both sections 35 and baffles 37 are coaxially aligned with axis 25 and coupling section 35 is secured to the radially inner surface 38c of screen 38. Any suitable coupling or securing method may be employed to mount coupling section 35 to surface 38c such as, for example, welding, sintering, bolts, rivets, an adhesive, or some combination thereof. As will be described in more detail below, during operation of system 10 each of the cups 34 and the generator 31 generate flow patterns within fluids being routed from the inner subchamber 23′, through screen 38 and into outer subchamber 23″ in order to promote substantially even distribution of particulates along surface 38c of screen 38 to enhance the performance of system 10. However, it should be appreciated that in other embodiments, the vortex generator 31 and/or the vortex generator cups 34 are not included in assembly 20.

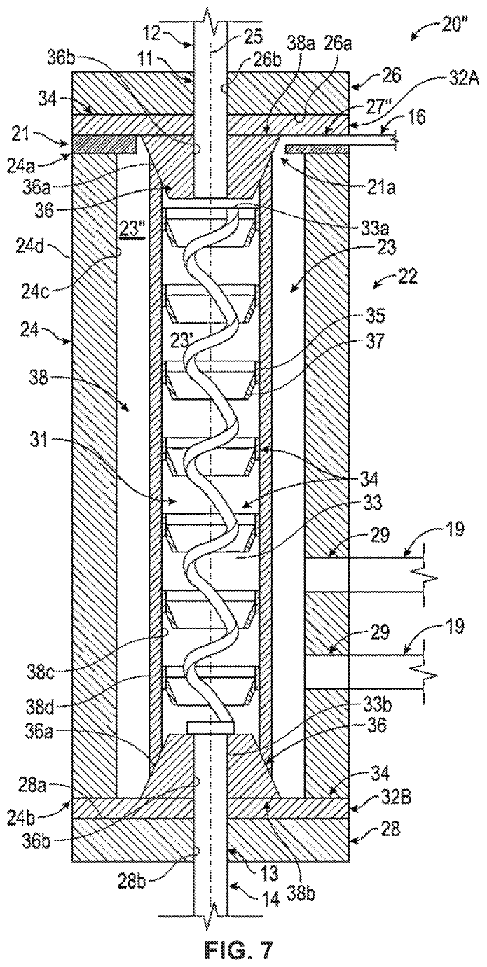

Referring briefly to FIG. 7, wherein another alternative embodiment of filter assembly 20″ is shown. Filter assembly 20″ includes many similar components relative to the filter assembly 20. As a result, like reference numerals are used for like components and features, and shared components may not be called out or discussed in detail with reference to FIG. 7, but the same description with regard to FIG. 2 applies equally to the assembly 20″ of FIG. 7 unless otherwise noted. Instead, the focus of the discussion will be on variations or differences in the filter assembly 20″ over the filter system 20. For example, in this embodiment, upper end 38a of screen 38 abuts or engages outer frustoconical surface 36a of intermediate cap 32A and lower end 38b of screen 38 abuts or engages outer frustoconical surface 36a of intermediate cap 32B. Additionally, assembly 20″ further includes a plate member 21 axially disposed between upper end 24a of body 24 and coupling portion 34 of intermediate cap 32A. Plate member 21 includes a axially oriented aperture or hole 21a configured to receive funnel portion 36 of upper intermediate cap 32A. In this embodiment, a main discharge fluid outlet 27″ is defined between the funnel portion 36 of intermediate cap 32A and the plate member 21. Specifically, during operation, fluid flows through the space between the aperture 21a and portion 36 of upper intermediate cap 32A and then through outlet 27″ into line 16. As a result, assembly 20″ does not include discharge outlet 27, previously described for assembly 20. Thus, through placement of the discharge outlet 27′ in the manner shown in FIG. 6, the surface 38c of screen is more fully utilized and thus may offer an enhanced ability to both control the disposition of particulates on inner surface 32c and induce cavitation within the fluid during operation. In some embodiments, the plate member 21, upper intermediate cap 32A, and upper cap 26 are all monolithically formed; however, it should be appreciated that in other embodiments, member 21, intermediate cap 32A, and cap 26 are not monolithically formed while still complying with the principles disclosed herein. In addition, in some embodiments of assembly 20″, no intermediate caps 32A, 32B are included (e.g., such as is the case for assembly 20′ shown in FIG. 3).

Referring back to FIG. 1, dirty tank 40 and clean tank 60 each comprise any suitable vessel or container capable of holding a volume of fluid (e.g., liquid and/or gas). In some embodiments, tanks 40, 60 may comprise a metal material; however, it should be appreciated that any suitable material (e.g., polymer, stainless steel, brass, composite(s)) may be used to construct tanks 40, 60 while still complying with the principles disclosed herein. Additionally, in other embodiments, tanks 40, 60 and may be disposed within a single container (not shown) such that each tank 40, 60 comprises a subchamber or section of the single container.

Referring still to FIG. 1, pumps 50, 52, 54, 56 may comprise any suitable device for inducing flow for a fluid. For example, pumps 50, 52, 54, 56 may comprise any type of centrifugal or positive displacement style pump. In this embodiment, pumps 50, 52, 54, 56 are centrifugal pumps that include an impeller (not shown). Further, in this embodiment, each of the pumps 50, 52, 54, 56 is coupled to a motor 51, 53, 55, 57 respectively, that is configured to rotate the impeller of each respective pump 50, 52, 54, 56, via a shaft, to induce a flow of fluid therethrough. As the rotational speed of the shaft of each motor 51, 53, 55, 57 increases, the discharge pressure of the pumps 50, 52, 54, 56, respectively, also generally increases. Similarly, as the rotational speed of the shaft of each motor 51, 53, 55, 57 decreases, the discharge pressure of the pumps 50, 52, 54, 56, respectively, also generally decreases. Motors 51, 53, 55, 57 may comprise any suitable type of motor or actuator while still complying with the principles disclosed herein. For example, in some embodiments motors 51, 53, 55, 57 may comprise electric motors, hydraulic motors, internal combustion engines, or some combination thereof. In this embodiment, motors 51, 53, 55, 57 are electric motors that are configured to rotate their respective output shafts in response to an electrical input signal (e.g., an electrical input signal supplied by controller 82).

Referring still to FIG. 1, control system 80 generally comprises a central controller 82 that is electrically linked to various components within system 10 through a plurality of electrical conductors 90. In some embodiments, conductors 90 comprise electrical cables that are physically coupled to the controller 82 and the various components within system 10; however, it should be appreciated that in other embodiments, controller 82 is linked to the various components through a wireless connection (e.g., Wi-Fi, BLUETOOTH®, acoustic, radio frequency (RF) waves, near field communication). Further, in this embodiment controller 82 includes programmable control logic, such as, for example, a proportional, integrator, derivative (PID) feedback control loop which, as will be described in more detail below, adjusts certain system parameters based on feedback obtained from measurements taken at various points throughout the system 10 in order to optimize cleaning operations. Specifically, while not specifically shown one having ordinary skill will appreciated that controller 82 may include, among other things, a memory and a processor for executing software stored on the memory. The memory of controller 82 may comprise volatile memory (e.g., random access memory), non-volatile memory (e.g., read only memory, hard disk drive, Flash storage, etc.), or combinations thereof. More generally, the controller 82 (including all components thereof) may comprise a hardware processor, microcontroller, microprocessor, an application specific integrated circuit (ASIC), and or any other type of circuit (or collection of circuits) that can perform the functions discussed herein. Thus, controller 82 may be referred to herein as a “controller circuit” or “controller circuits.”

Control system 80 also includes a plurality of sensors that are disposed within and between the various components of system 10 to measure various system parameters during operation thereof. In some embodiments, each of the sensors is configured to both sense a given parameter and transmit (e.g., through one of the conductors 90) data containing the measured value (or data indicative of the measured value) for processing. In this embodiment, a pressure sensor 81 is disposed along feed line 11 between pump 50 and assembly 20, an acoustic sensor 83 is coupled to vessel 22 of assembly 20, a pressure sensor 85 is disposed along flush line 12, a conductivity sensor 87 and a pressure sensor 89 are disposed along discharge line 16, a pressure sensor 84 is disposed along return line 15, a conductivity sensor 92 is coupled to start tank 40, and a pressure sensor 93 is disposed along discharge line 16 between pump 54 and polisher 100. Additionally, in this embodiment, a flow rate sensor 91 is shown disposed along flush line 12; however, it should be appreciated that in other embodiments, multiple flow rate sensors (e.g., sensor 91) may be disposed throughout the system 10 to measure the flow rate of fluids flowing therethrough during operation. In other embodiments, the sensor 83 may comprise a pressure, flow rate, or other sensor. As is shown in FIG. 1, each of the sensors 81, 83, 84, 85, 87, 89, 91, 92, 93 are electrically coupled to controller 82 through conductors 90 previously described. Further, pressure sensors 81, 84, 85, 89, 93 may comprise any suitable sensor for measuring the pressure of a fluid. For example, in some embodiments, pressure sensors 81, 84, 85, 89, 93 comprise ultrasonic sensors. Also, in some embodiments, pressure sensors are disposed in other portions of the filter system 10, such as within the assembly 20.

System 80 further includes a plurality of variable frequency drives (VFD(s)) 86, 88, 94 that are electrically coupled to controller 82 through conductors 90. In particular, a first VFD 86 is electrically coupled to motor 51, a second VFD 88 is electrically coupled to motor 53, and a third VFD 94 is electrically coupled to motor 55. Each of the VFDs 86, 88, 94 is configured to control the rotational speed of the motors 51, 53, 55, respectively, by altering the electrical signal being routed to the motors 51, 53, 55, respectively. Because the discharge pressure of the pumps 50, 52, 54 is generally related to the rotational speed of the motors 51, 53, 55, respectively, as previously described, the VFDs 86, 88, 94 are thus configured to alter the discharge pressure of pumps 50, 52, 54, respectively, during operation of system 10. The VFDs 86, 88, 94 provide a fine level of control for the rotational speeds of the motors 51, 53, 55 and thus the discharge pressures of the pumps 50, 52, 54.

Still further, as is shown in FIG. 1, in this embodiment controller 82 is also electrically coupled (e.g., through conductors 90) to each of the actuatable valves 43, 44, 45, 47, 48, 62, 63, 64 previously described. Because of this connection, controller 82 is configured to actuate each of the actuatable valves 43, 44, 45, 47, 48, 62, 63, 64 to adjust and control the flow of fluid throughout system 10 during operations. In should be appreciated that in other embodiments, controller 82 may only be configured to actuate some of the actuatable valves 43, 44, 45, 47, 48, 62, 63, 64, and in still other embodiments, controller 82 may be configured to additionally or alternatively track and monitor the open and closed states (or the degree or opening or closing) of one or more of the actuatable valves 43, 44, 45, 47, 48, 62, 63, 64.

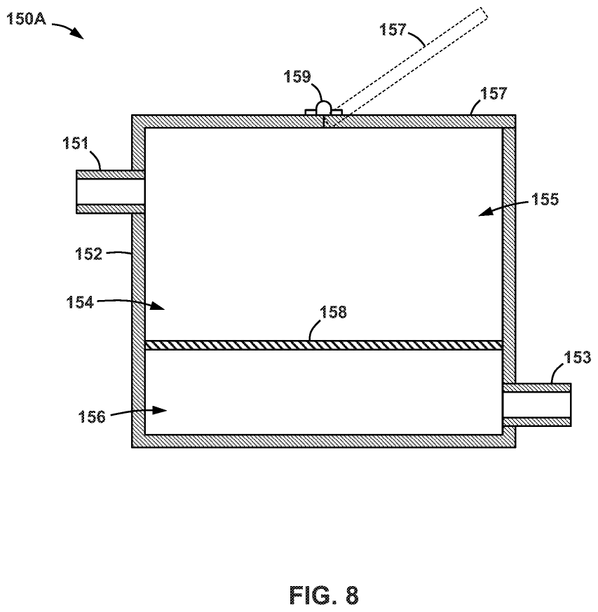

Referring now to FIG. 8, first solids collector 150A is schematically shown, it being understood that second solids collector 150B is configured the same. First solids collector 150A is configured to strain or filter out solid particulates that are suspended within the fluid (e.g., fluid 3 described below) being filtered by system 10. In this embodiment, filter assembly 150A includes a body 152 defining an inner chamber 154. A filtering membrane 158 is disposed within chamber 154, thereby dividing chamber 154 into a first subchamber 155 and a second subchamber 156. An inlet port 151 communicates with first subchamber 155 through the wall of body 152 and an outlet port 153 communicates with second subchamber 156 through the wall of body 152.

Membrane 158 may comprise any suitable material for filtering out suspended solids within a fluid. For example, in this embodiment, membrane 158 comprises a hybrid felt that further comprises a combination of polyester and rayon that is melt blown to form membrane 158. In other embodiments, other materials (e.g., other types of felt) may be used to construct membrane 158.

Referring still to FIG. 8, in this embodiment, a lid or access cover 157 is hingeably coupled to body 152 with a hinge assembly 159. During normal operations, lid 157 is sealingly closed against body 152 (i.e., in the position shown with a solid line in FIG. 8) so that chamber 154 (particularly subchamber 155) is sealed from the outer environment. However, when it becomes desirable to access chamber 154 (e.g., to access/replace/repair membrane 158, to clean collected solid particulates off of membrane 158, etc.) lid 157 may be rotated about hinge assembly 159 to an open position (shown in a dotted line in FIG. 8). In other embodiments, a different mechanism, lid, covering, etc. may be included for access to chamber 154 (including subchambers 155, 156), other than lid 157. Also, in some embodiments, no such access covering, lid, etc. may be included on body 152.

During operations, fluid (e.g., the fluid 3 being filtered by system 10) enters subchamber 155 via inlet port 151 and flows across filter membrane 158 into subchamber 156. If any solid materials are entrained or suspended within the fluid as it flows between subchambers 155, 156, at least some of these solid materials (i.e., any solid materials that are larger than any perforations or flow paths extending through membrane) are deposited on membrane 158 within subchamber 158.

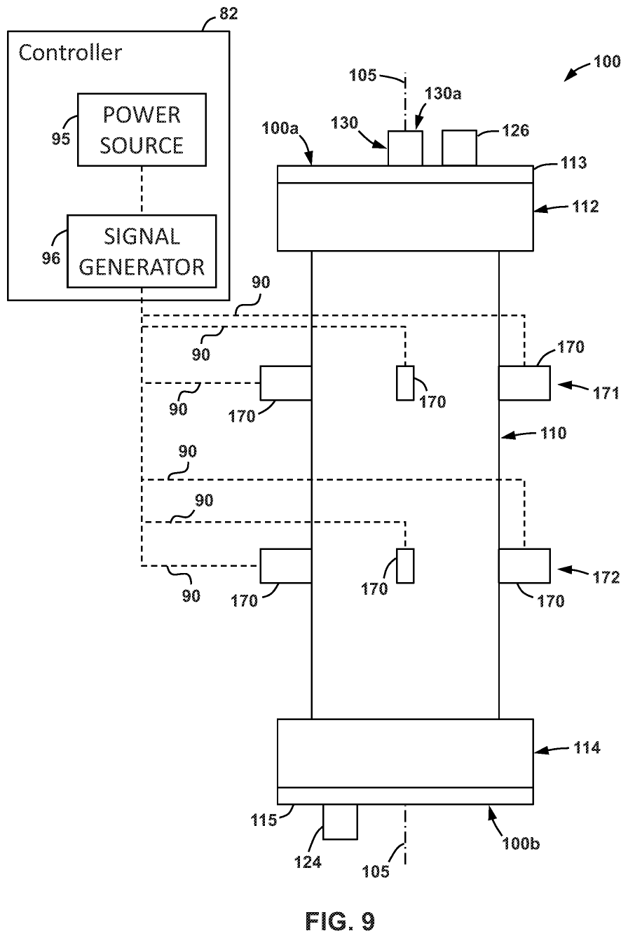

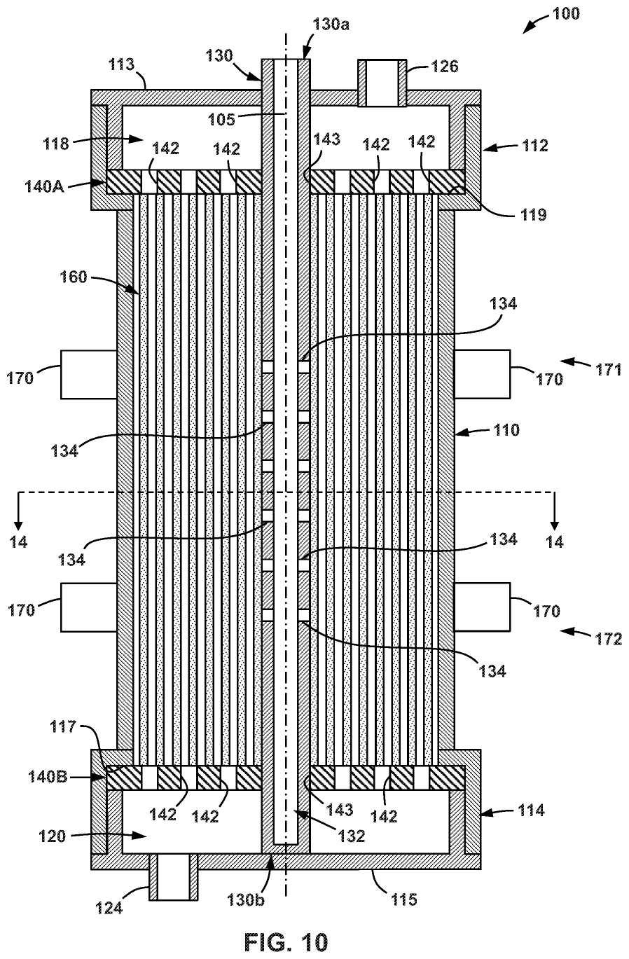

Referring now to FIGS. 9 and 10, polisher 100 includes a central or longitudinal axis 105, a first or upper end 100a, and a second or lower end 100b opposite upper end 100a. In addition, polisher 100 includes a first or upper cylindrical head 112, a second or lower cylindrical head 114, and a central cylindrical body 110 extending axially between heads 112, 114. Upper head 112 defines a first or upper channel 118, lower head 114 defines a second or lower channel 120, and central body 110 defines a central cylindrical cavity 122 extending axially between channels 118, 120. Upper and lower heads 112, 114 have larger inner diameters than central body 110, and thus, a first or upper annular shoulder 119 is formed between upper channel 118 and central cavity 122, and a second or lower annular shoulder 117 is formed between lower channel 120 and central cavity 122.

As shown in FIG. 10, a pair of diffusers are disposed within channels 118, 120 to evenly direct the flow of fluids out of and into central cavity 122 during operations. Specifically, a first or upper diffuser 140A is disposed within upper channel 118 and is engaged with upper annular shoulder 119, and a second or lower diffuser 140B is disposed within lower channel 120 and is engaged with lower annular shoulder 117. Generally, diffusers 140A, 140B are perforated plates that include a plurality of distributed flow ports 142. The structural details of one embodiment of diffusers 140A, 140B will be described below, it being understood and appreciated that other specific designs are possible.

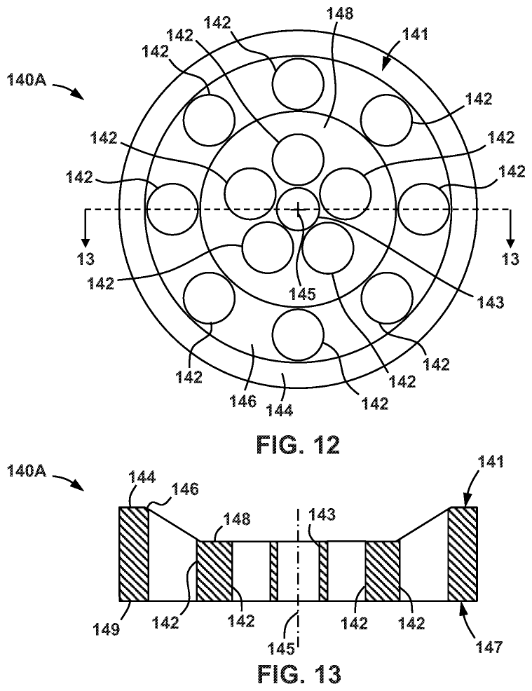

Referring now to FIGS. 12 and 13, an embodiment of upper diffuser 140A is shown, it being understood that lower diffuser 140B may be configured the same. Diffuser 140A includes a central axis 145, a first side 141, and a second side 147 opposite first side 141. When upper diffuser 140A is disposed within upper chamber 118, axis 145 is generally aligned with axis 105 of polisher 100. First side 141 includes a first annular planar surface 144, a second planar surface 148 that is axially spaced from first annular planar surface 144, and a frustoconical surface 146 extending between planar surfaces 144, 148. Second side 147 includes a planar surface 149.

In this embodiment, flow ports 142 extend axially between sides 141, 147 both on frustoconical surface 146 and on planar surface 148 at first side 141, and none of the flow ports 142 extend through planar surface 144. Additionally, a central through hole or port 143 extends between sides 141, 147 on planar surface 148 along axis 145 (i.e., at the center of diffuser 140A). In this embodiment, second side 147 of diffuser 140A engages with annular shoulder 119 in upper channel so that first side 141 (including surfaces 144, 146, 148) faces upper channel 118. Likewise, it should be appreciated that second side 147 of diffuser 140B engages with annular shoulder 117 in lower channel 120, so that first side 141 (including surfaces 144, 146, 148) on diffuser 140B faces lower channel 120.

Referring back now to FIGS. 9 and 10, a core tube 130 extends axially through each of the upper channel 118, central cavity 122, and lower channel 120 along axis 105. Core tube 130 includes a first or open end 130a, a second or closed end 130b opposite open end 130a. Open end 130a extends through upper channel 118, whereas closed end 130b is disposed within lower channel 120. In addition, core tube 130 extends through the central port 143 in each of the diffusers 140A, 140B. Conduit defines a central flow path or bore 132 and includes a plurality of radially extending lateral ports 134 that provide communication between bore 132 and central cavity 122.

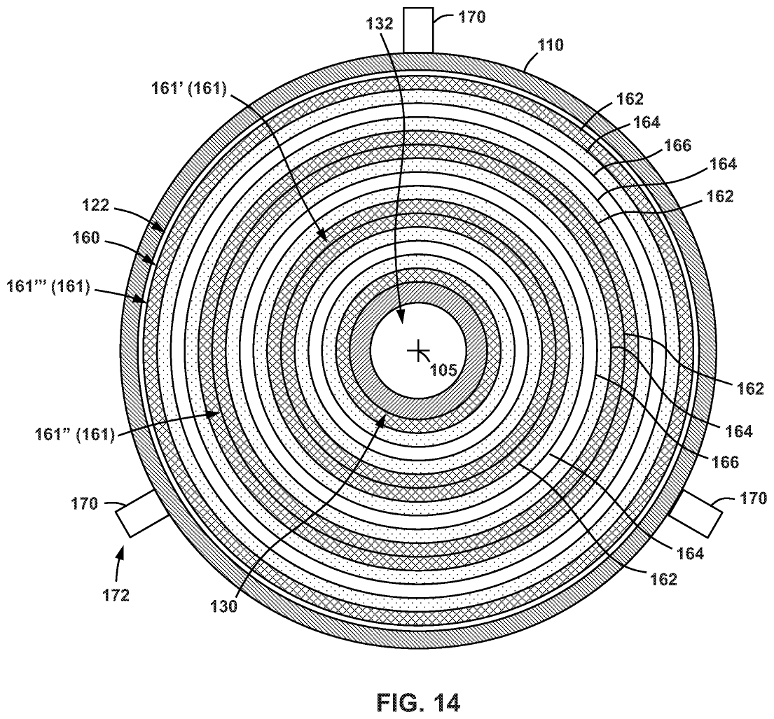

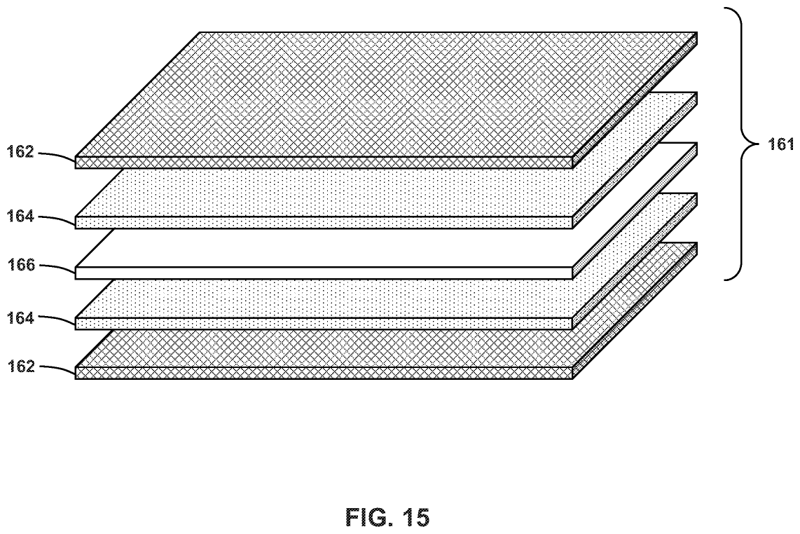

Referring specifically to FIG. 10, polisher 100 also includes a filter unit 160 disposed within central cavity 122. Specifically, in at least some embodiments filter unit 160 substantially fills central cavity and is disposed about core tube 130. As a result, filter unit 160 is axially contained or bounded between diffusers 140A, 140B. Filter unit 160 includes a plurality of radially stacked layers for performing additional filtering of fluids that are emitted from filter assembly 20 (e.g., along discharge line 16). Specifically, referring now to FIG. 14, in this embodiment filter unit 160 may be made up of one or more filter membrane assemblies 161 that each comprise a plurality of radially stacked layers generally cylindrically extending about axis 105. Specifically, referring now to FIGS. 14 and 15, in this embodiment each filter membrane assembly 161 includes two layers of spacer material 162, two layers of filtering membrane material 164 disposed between the layers of spacer material 162, and a layer of permeable material 166 disposed between the layers of filtering membrane material 164.

The spacer material 162 may comprise a permeable mesh of a metallic material (e.g., stainless steel). The function of spacer material 162 is to provide sufficient spacing (e.g., radial spacing with respect to axis 105) between adjacent layers of filter membrane material 164 of radially adjacent filter membrane assemblies 161 within filter unit 160. In at least some embodiments, filter membrane material 164 may comprise a 1 micron to 20 Dalton semi-permeable membrane that is made from polyamide and polysulfone. Further, permeable material 166 may comprise a substantially permeable layer of felt or some other suitable material such that fluid (e.g., water) may flow substantially freely therethrough. For example, in some embodiments, permeable material 166 may comprise melt blow polyester, rayon, polyethylene or polyvinyl chloride (PVC).

As shown in FIG. 14, in this embodiment, there are total of three filter membrane assemblies 161 concentrically arranged with respect to axis 105, wherein each filter membrane assembly 161 is cylindrically (or circumferentially) wrapped about axis 105. As shown in FIG. 14, in this embodiment, filter unit 160 comprises a first or inner filter membrane assembly 161′ concentrically disposed about core tube 130, a second or middle filter membrane assembly 161″ concentrically disposed about inner filter membrane assembly 161′, and a third or outer filter membrane assembly 161′″ concentrically disposed about middle filter membrane assembly 161″. Each of the filter membrane assemblies 161′, 161″, 161′″ are configured the same. Specifically, each filter membrane assembly 161′, 161″, 161′″ includes the layers shown in FIG. 15 and described above; however, one having ordinary skill will appreciate that the individual layers 162, 164, 166 may be differently sized among assemblies 161′, 161″, 161′″ due to their respective radial position within filter unit 160).

Referring again to FIG. 10, polisher 100 also includes a first or upper cover or lid 113 and a lower cover or lid 115. Lid 113 engages with upper head 112 to enclose upper channel 118, and lower lid 115 engages with lower head 114 to enclose lower channel 120. An inlet port 124 providing communication into lower channel 120 is provided on lower lid 115, and an outlet port 126 providing communication out of upper channel 118 is provided on upper lid 113. In addition, upper, open end 130a of core tube 130 extends through upper lid 113. Filter unit 160 is disposed between diffusers 140A, 140B such that second side 147 of each diffuser 140A, 140B engages with filter unit 160 to retain filter unit 160 within central cavity 122. When lids 113, 115 are secured to heads 112, 114, respectively, lids 113, 115 engage or abut with diffusers 140A, 140B, respectively, to thereby secure diffusers 140A, 140B and filter unit 160 within polisher 100.

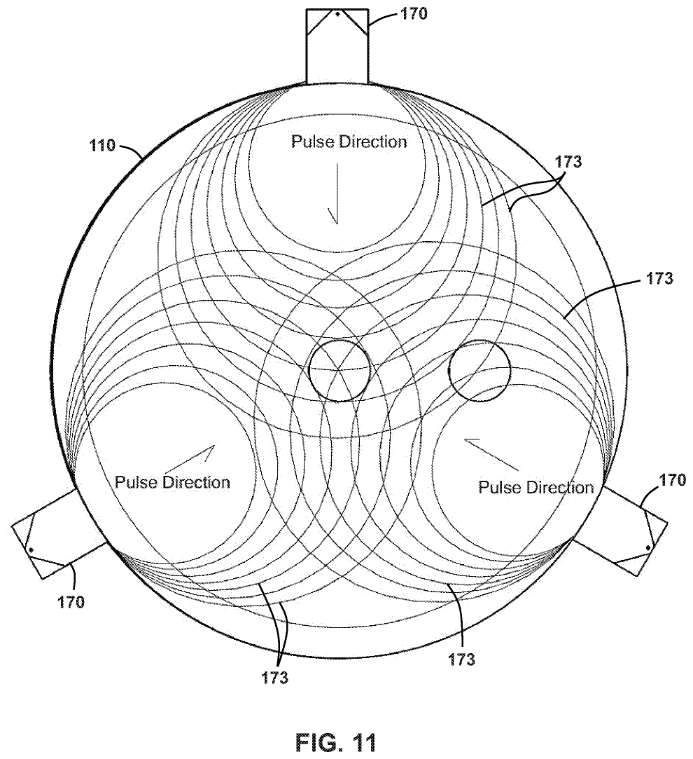

Referring back now to FIGS. 9 and 10, a plurality of transducers 170 coupled to the radially outer surface 116 of central cylindrical body 110. Each of the transducers 170 are configured to deliver specific frequencies of ultrasonic waves. Specifically, as schematically shown in FIG. 11, because these transducers are mounted so as to be azimuthally separated from one another, when engaged, they deliver intersecting sonic and electromagnetic waves 173 to the surfaces of the filter unit 160 resulting in process enhancement. As a result of the process, the filter unit 160 (e.g., layers 162, 164, 166) undergoes constant cleaning, which further extends the life thereof. Clean permeated water flow and quality are also increased and improved as a result of the intersecting (ripple) waves. Thus indicates that mechanical vibration and electroporation are occurring at the filter unit 160.

Referring back to FIGS. 9 and 10, in this embodiment, transducers 170 are arranged in two axially spaced rows—specifically a first or upper row 171 disposed along central cylindrical body 110 and a second or lower row 172 axially disposed between upper row 171 and lower head 114 along body 110. Each row 171, 172 comprises one or more evenly circumferentially spaced (with respect to axis 105) transducers 170. In this embodiment, each row 171, 172 includes a total of three transducers 170, and thus, the transducers 170 of each row 171, 172 are circumferentially spaced approximately 120° apart from each adjacent transducer 170 within that row 171, 172. In addition, in at least some embodiments, rows 171, 172 of transducers 170 may comprise integrated ring structures (i.e., ring structures that contain each of the transducers 170 of that particular row 171. 172) that are mounted to radially outer surface 116 of cylindrical body 110.

As shown in FIG. 9, each of the transducers 170 are coupled to controller 82. In particular, each of the transducers 170 are coupled to each of a signal generator 96 and a power source 95 within controller 82 via an electrical conductor 90, which are generally the same as described above. Thus, during operations, signal generator 96 generates a desired, pre-determined electric output signal (e.g., a signal which is determined, calculated, and/or derived by software executed by a processor in controller 82) that is routed to one or more or each of the transducers 170 during operation to facilitate the oscillating magnetic field across filter unit 160 in the manner described above. Power source 95 may provide the electrical power that is used by signal generator 96 to generate the electric signals discussed above. Alternatively, controller 82 may not carry an internal, on board power source and may instead draw power from another, external source (e.g., local generator, local utility power grid, etc.).

Referring again to FIGS. 10 and 14, during operations fluid (e.g., the fluid being filtered by system 10) enters polisher 100 at inlet port 124, and then flows into lower channel 120. Upon entering lower channel 120, the fluid is then directed axially into filter unit 160 via the flow ports 142 extending through diffuser 140B. Thereafter, the fluid flows radially through each (or at least some) of the layers of filter materials 162, 164, 166 of the concentrically arranged filter membrane assemblies 161′, 161″, 161′″. Eventually some fluid flows radially into bore 132 of core tube 130 via one or more of the flow ports 134. Because the fluid entering bore 132 of core tube 130 has passed through one or more of the filter membrane assemblies 161′, 161″, 161′″, it is substantially free of all particulates and impurities. Thus, the fluid exiting filter unit 160 via core tube 130 may be referred to herein as “finely filtered fluid.” This finely filtered fluid is then routed axially through bore 132 and out of polishing assembly 100 at upper end 130a of core tube 130.

Conversely, some fluid eventually flows axially through filter unit 160 (e.g., via the layers of permeable material 166) and eventually exits filter unit 160 via the flow ports 142 in upper diffuser 140A and flows into upper channel 118. Because at least some of the fluid exiting filter unit 160 via flow ports 142 in diffuser 140A has not passed radially through many or any of the layers of filter membrane assemblies 161′, 161″, 161′″, there may still be some dissolved or suspended particulate matter or impurities entrained therein. Thus, the fluid exiting filter unit 160 at flow ports 142 in upper diffuser 140A may be referred to herein as “semi-filtered fluid.” This semi-filtered fluid then flows out of channel 118 and polishing assembly 100 via outlet port 126.

During these filtering operations with polisher 100, transducers 170 generate oscillating electric and magnetic fields across filter unit 160 in the manner described above. These oscillating electric and magnetic fields cause cyclical retractions of magnetic components (e.g., layers of metallic spacer materials 162 within filter membrane assemblies 161′, 161″, 161′″), that result in acoustic waves (e.g., ultrasonic acoustic waves) and vibrations that emanate across filter unit 160 that help to dislodge any particulate materials that is lodged within any of the layers (e.g., layers of materials 162, 164, 166) in filter membrane assemblies 161′, 161″, 161′″. In addition, these cyclic contractions of one or more of the layers within filter unit 160 also cyclically vary the permeability of the layers of filter unit 160 which thereby results in a reduction in the hydraulic resistance thereof and allows for an increased fluid flow rate across filter unit 160 at lower relative pressures during operations. In some embodiments, the transducers 170 may induce a cyclically varying electric and/or magnetic field across filter unit 160 as described above; however, in other embodiments transducers 170 may induce a pulsing or pulsed electric and/or magnetic field across filter unit 160. In still other embodiments, other types of varying electric and/or magnetic fields may be induced to enhance and control the filtering operations of polisher 100 as described herein.

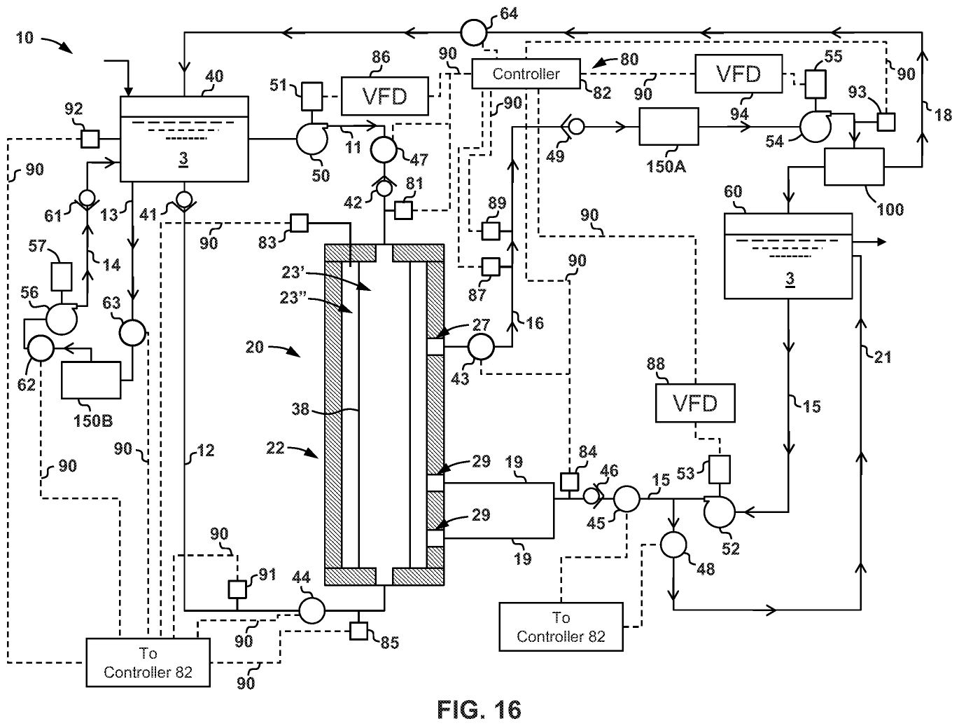

Referring now to FIG. 16, the system 10 is generally operable in a filtering state during which tank 40 receives fluid 3 (e.g., used flowback frac water, salt water, fluid produced from a subterranean mine, etc.) from a source (not shown) (e.g., an oil and gas well). The fluid 3 within tank 40 includes several impurities including, among other things, suspended solids and other dissolved impurities. For example, in some embodiments, impurities disposed within fluid 3 include long chain hydrocarbons, benzene, toluene, ethylbenzene, calcium, metals, chlorides (e.g., sodium chloride), or some combination thereof. From tank 40, fluid 3 is pumped, via feed pump 50, from tank 40, through line 11 and check valve 42, and into assembly 20. Referring briefly again to FIGS. 2 and 4, fluid 3 enters subchamber 23′ of chamber 23 through inlet 11 and flows through holes 39 in screen 38 (or apertures 39′A, 39′B in screen 38′ shown in FIG. 5) toward chamber 23″. Any suspended solids which are larger than the maximum diameter D₃₉ of holes 39 are deposited on the radially inner surface 38c of screen 38, thus filtering such matter out of the dirty fluid 3. In addition, due to the velocity of the fluid as well as other factors such as, for example, the geometry of the chamber 23, the geometry of the intermediate caps 32A, 32B (for embodiments employing intermediate caps 32A, 32B), and the vortex generators 31, 34 (for embodiments employing generators 31, 34) flow patterns are created in fluid 3 within subchamber 23′ to promote a relatively even coating of suspended solids on the radially inner surface 38c of screen 38.

Referring still to FIG. 16, after passing through screen 38 and into outer subchamber 23″, the fluid 3 then flows out of subchamber 23″ through outlet 27 (or outlet 27″ for embodiments employing assembly 20″ shown in FIG. 7). As previously described, line 16 is fluidly coupled to outlet 27 and thus provides a fluid flow path for fluid 3 from assembly 20 to solids collector 150A and polisher 100. During this process, valve 43 is actuated to the open position by controller 82 to allow fluid 3 to freely flow out from assembly 20.

Once fluid 3 exits outlet 27, it flows along discharge line 16 to first solids collector 150A. Specifically, as shown in FIG. 8, and as previously described above, fluid 3 flows across membrane 158 such that at least some of any solid materials that are suspended within fluid 3 are deposited on membrane 158. Referring again to FIG. 16, after exiting first solids collector 150A via, the fluid 3 flows to delta pump 54 where it is pressurized to a desired level prior to entering polisher 100. For example, in at least some embodiments, controller 82 controls the output pressure of pump 54 via VFD 94 so that the pressure of fluid 3 is effectively drawn down downstream of first solids collector 150A, and so that the pressure of fluid 3 is at a predetermined and desired level for entrance into polisher 100. Pressure sensor 93 provides a reading of the discharge pressure of pump 54 during operations. Thus, controller 82 may monitor the output from pressure sensor 93 as a feedback for controlling the operation of pump 54 (e.g., via VFD 94).

Referring again to FIGS. 10 and 14, after being discharged from pump 54, the fluid 3 continues to flow along discharge line 16 to polisher 100. As previously described, upon entering polisher 100 at inlet port 124, the fluid 3 either traverses radially through filter unit 160 and eventually into core tube 130 or is routed axially through filter unit 160 toward outlet port 126. Referring again to FIG. 16, the finely filtered fluid 3 exiting upper end 130a of core tube 130 is directed into finish tank 60, where it may then be reused (e.g., reinjected into a subterranean wellbore), introduced into the natural environment (e.g., pumped into a river, lake or the ocean), stored, etc. By contrast, the semi-filtered fluid 3 exiting polisher 100 via outlet port 126 flows through polisher return line 18 to start tank 40, where it may then be reprocessed through system 10 until it eventually exits polisher 100 via upper end 130a of core tube 130 (see FIG. 10) and flows into finish tank 60.

Referring still to FIG. 16, from tank 60, the cleaned and finely filtered fluid 3 may be discharged from the system 10 and/or pumped back to the original source for further use as previously described. In addition, in this embodiment, at least a portion of the fluid in tank 60 is directed through return line 15 by pump 52. Further, some of the fluid discharged by reversing pump 52 flows into recirculation line 21 and back into tank 60 to ensure a sufficient level of fluid within tank 60 during operation. In some embodiments, the flow of fluid through recirculation line 21 establishes a reduction bypass flow path, the size of which varies depending upon the pressure within the system and the disposition of solids along the surface 38c of screen 38. For example, in some embodiments, the flow of fluid through the recirculation line 21 establishes about a 50% reduction bypass flow path (when compared with the feed flow rate into assembly 20); however, in other embodiments, the size of the bypass flow path may be more or less than 50% while still complying with the principles disclosed herein.

In addition, as is shown in FIG. 16, during the filtration operations described herein (e.g., and shown in FIG. 16) the valve 45 is open; however, the pressure within subchamber 23″ is typically higher than the pressure in line 15. As a result, fluid communication between subchamber 23″ and the line 15 is at least significantly restricted by the check valve 46. However, when the pressure in subchamber 23″ is less than the pressure in line 15, some fluid 3 is allowed to flow past check valve 46 through injection lines 19 and into subchamber 23″. This small amount of flow into the subchamber 23″ from the lines 19 ensures fluid circulation in the subchamber 23″ thereby reducing the likelihood of particulate matter from becoming completely lodged within screen 38. Therefore, during the above described operations, use of components such as, for example, VFD 88 and pump 52 allows for a reduction in the amount of particulate disposition on screen 38 while also simultaneously producing filtered fluid 3 to tank 60 and fine tuning the pressure within subchamber 23″ to optimize cavitation (discussed below) within filter assembly 20.

Alternatively, system 10 may also be operated such that valve 45 is closed. As a result, fluid 3 is pumped through assembly 20, solids collector 150A, polisher 100, and then into tank 60 as previously described above; however, because the valve 45 is closed, no or substantially no fluid is allowed to return to subchamber 23″, thus reducing the amount or level of fluid circulation in the outer subchamber 23″ through lines 19. In some embodiments, the decision to open or close valve 45 is determined by a number of factors such as, for example, the specific type of fluid 3 or impurities contained within fluid 3, the amount of impurities contained within fluid 3, and the specific gravity of fluid 3.

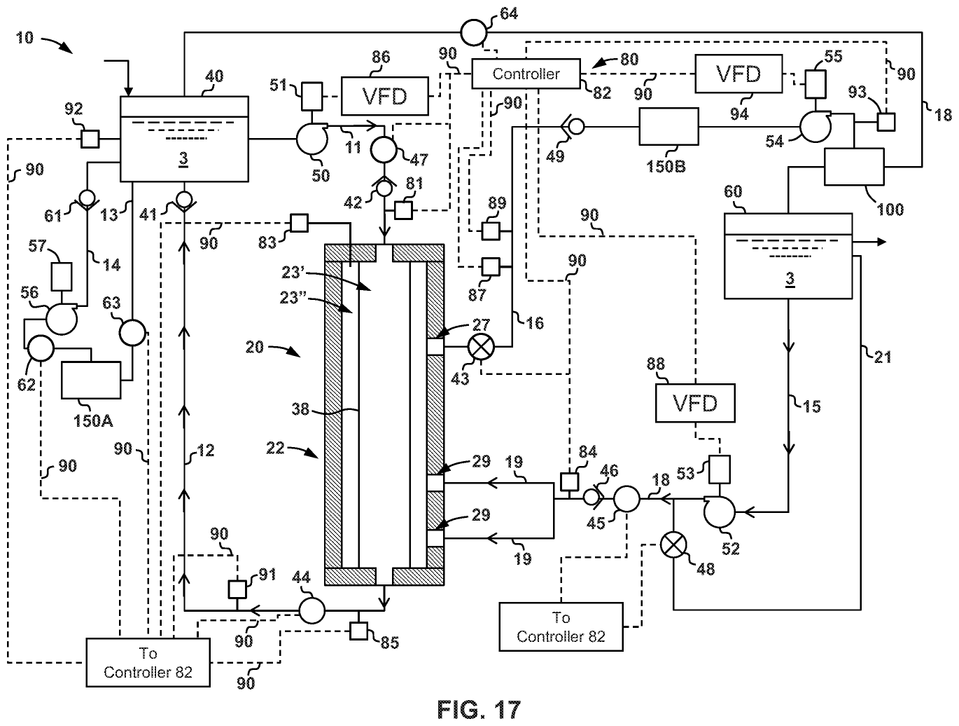

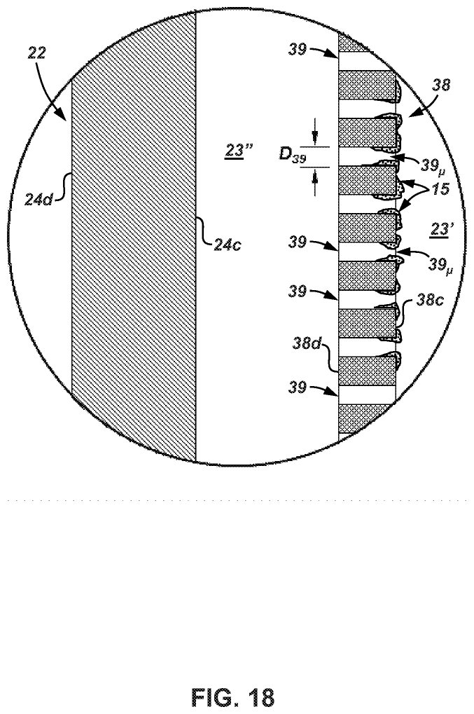

Referring now to FIG. 17, regardless of whether the valve 45 is open or closed during operations, over time, particulate matter begins to build up along the radially inner surface 38c of screen 38 (see FIG. 2), such that it becomes necessary for system 10 to enter a reject state in which fluid flow is reversed within assembly 20 to sweep or clean at least a portion of this buildup from screen 38. In particular, the controller 82 closes valves 43 and 48 and opens the valves 44 and 45. Once the valve 48 is closed, the pressure within line 15 increases (e.g., due to the influence of pump 52) such that it is greater than the pressure within subchamber 23″, thereby allowing fluid to flow from line 15, through check valve 46, into the injection lines 19, and into the inlets 29, previously described. After fluid enters outer subchamber 23″ from inlets 29, it flows through the holes 39 in screen 38 from the radially outer surface 38d to the radially inner surface 38c and into the inner subchamber 23′ thereby dislodging or sweeping any suspended solids that have built up along surface 38c. As shown in FIG. 17, multiple lines 19 and inlets 29 are provided to allow the fluid flowing into the subchamber 23″ to enter at multiple points, and thereby promote cleaning or sweeping of most if not the entire surface 38c of screen 38. Once fluid has entered the inner subchamber 23′ from lines 19, it is blocked or restricted from flowing back through line 11 into tank 40 by check valve 42. However, because the valve 44 is open, the fluid and the swept particulate matter is allowed to flow from inner chamber 23′ through fluid outlet 9 and into flush line 12. In this embodiment, flush line 12 directs the fluid from assembly 20 back to dirty tank 40; however, it should be appreciated that in other embodiments, line 12 may direct the fluid to another separate tank (other than tank 40 or tank 60) or may expel the fluid from the system 10 entirely. In addition, it should be appreciated that in some embodiments, keeping valve 45 open during filtering operations as previously described (see FIG. 16) may allow an operator to minimize the amount of time the system 10 must be run in a reject state (e.g., as shown in FIG. 17) due to the small amount of recirculation back into the chamber 23″ through lines 19, thereby increasing the amount of time that system 10 may be run to continuously filter fluids (e.g., fluid 3) during operation. In addition, when operating system 10 in a reject state as described above, valve 64 may either be open or closed such that fluid 3 may or may not, respectively, flow from polisher 100 (particularly from outlet 126 of polisher 100—see FIG. 10) back to tank 40 via polisher return line 18 as described above.

Referring again to FIG. 16, during filtering operations and/or during a reject state operation, solid materials that are suspended within fluid 3 and that settle within start tank 40 may be filtered out and captured prior to routing fluid 3 through filter assembly 20, solids collector 150A, polisher 100 via a start tank 40 flushing operation. In particular, as shown in FIG. 16, during a flushing operation, valves 63, 62 may be opened (e.g., by controller 82) and pump 56 may be operated to draw fluid 3 from tank 40 (particularly a bottom portion of tank 40) toward second solids collector 150B via a tank solids rejection line 13. Specifically, as shown in FIG. 8, and as previously described above, fluid 3 flows across membrane 158 within second solids collector 150B such that at least some of any solid materials that are suspended within fluid 3 are deposited on membrane 158. Referring back to FIG. 16, after exiting outlet port 153 of second solids collector 150B, the fluid 3 then flows through pump 56 and back to start tank 40 via a tank return line 14. Thus, during a start tank 40 flushing operation, solid particulates that are suspended within fluid 3 in tank 40 may be at least partially filtered out of the filtered fluid 3 prior to routing the fluid 3 through either of the filter assembly 20 or the polishing assembly 100. The start tank 40 flushing operation may be continuously performed while also routing fluid 3 through filter assembly 20, first solids collector 150A, polisher 100, etc.

The semi-filtered fluid flowing back into start tank 40 from outlet 126 of polisher 100 via polisher return line 18 contains some amount of dissolved particulate matter (which may be ionic in quality) so that over time, the concentration of dissolved particulate matter in tank 40 rises so that the conductivity of fluid 3 in tank 40 also rises. Eventually, the concentration of dissolved particulate matter rises above the individual saturation points for the dissolved elements so that these dissolved elements precipitate out of the fluid 3. In at least some embodiments, start tank 40 may include a collection feature, profile, or shape, etc. to gather or collect the settle particulate matter. For example, in at least some embodiments, tank 40 may include a funnel shape or profile at a lower end thereof. Once settled, the precipitated particulates may then be captured via the start tank 40 flushing operation described above. Therefore, the flow of concentrated semi-filtered fluid from polisher 100 (particularly outlet port 126 of polisher 100) aids in pre-filtering dissolved particulates out of fluid 3 prior to routing at least some of the fluid 3 through filter assembly 20, solids collector 150A, or polisher 100.

In at least some embodiments, a conductivity sensor 92 is mounted to start tank 40 that is configured to measure or monitor the conductivity of the fluid 3 disposed therein. By tracking the conductivity of the fluid 3 within tank 40, operators (and/or controller 82) may determine whether the flow back from polisher 100 along polisher return line 18 is most effectively increasing the conductivity of tank 40 to encourage the precipitation of dissolved particulate matter out of fluid 3. As a result of the conductivity measurement, operators (and/or controller 82) may adjust other elements of the system (e.g., adjust valves, pumping rates, etc.) to increase/decrease flow from polisher 100 to tank 40 via line 18.

Referring still to FIG. 16, during operation of system 10, control system 80 takes in measurements from the various sensors (e.g., sensors 81, 83, 84, 87, 89, 92, 93) and adjusts the speeds of the pumps 50, 52, 54 through the VFDs 86, 88, 94, respectively, and actuates the valves 43, 44, 45, 47, 48, 63, 64 to enhance and optimize the cleaning of impurities from fluid 3. As previously described, in this embodiment, controller 82 comprises a PID control loop (or circuit). In general, the controller 82 receives the measured values of pressure both from the inner subchamber 23′ via the sensor 81 and from the outer subchamber 23″ via the sensor 89 during operation. The controller 82 then adjusts the rotational speed of motor 51 and pump 50 through VFD 86, in the manner previously described, to adjust the discharge pressure from pump 50 and thus the pressure within the inner chamber 23′ relative to the pressure within outer chamber 23″. In some embodiments, the controller 82 adjusts the rotational speed and thus the discharge pressure of pump 52 either in addition to or in lieu of adjusting the discharge pressure of the pump 50 to further optimize and control the pressure difference between the subchambers 23′, 23″. Because of the fine level of control provided by the VFDs 86, 88, the discharge pressures of the pumps 50, 52 can be controlled quickly, continuously, and at various rates of change.

Generally speaking, the goal of these adjustments by controller 82 is to maintain a predetermined pressure differential or pressure ratio between the subchambers 23′, 23″ to induce and maintain cavitation within the fluid 3 and further precipitate out dissolved solids from fluid 3 in addition to filtering suspended solids during operation. For example, as previously described, during normal operation of system 10, fluid 3 is pumped or flowed from the inner subchamber 23′ to the outer subchamber 23″ such that screen 38 may clean or strain suspended solids therefrom. As is best shown in FIG. 18, during this process suspended solids within fluid 3 collect or accumulate as deposits 15 along the radially inner surface 38c of screen 38 and thus partially clog the holes 39, thereby reducing the effective maximum diameter or clearance D₃₉ and creating “micro-apertures” or “micro-holes” 39_{μ}. Without being limited by this or any particular theory, as fluid flows through the newly formed micro-holes 39_{μ}, the pressure drops at the throat of constriction thereby allowing the static pressure of fluid 3 to fall below the vapor pressure, and thus causing cavitation to occur. As cavitation occurs within the holes 39_{μ}, the solubility of the fluid is altered and dissolved solids (e.g., sodium chloride, NaCl) within the fluid begin to crystalize. In particular, as fluid cavitation occurs, small bubbles form which then subsequently collapse thereby releasing an amount of kinetic energy. The released energy operates to dissociate polar water molecules from surrounding cations and anions, which were previously bonded to the water molecules in the aqueous solution. The newly released cations and anions then recombine and thus precipitate out of solution in the form of crystals. These newly formed crystals adhere to the nucleation sites formed by deposits 15 distributed along the radially inner surface 38c and thus are also filtered out of the fluid 3. In order for cavitation to occur in the manner described above, the effective diameter D₃₉ of the micro-holes 39_{μ} must fall within a certain range. In at least some embodiments, the pressure differential between the subchambers 23′, 23″ is directly related to the size of the micro-holes Thus, at least one goal of the control system 80 is to optimize the pressure differential or pressure ratio between subchamber 23′, 23″ such that micro-holes form along the radially inner surface 38c of screen 38 thereby allowing cavitation to occur within and proximate the holes 39_{μ} to enhance the assembly 20's (or the assemblies 20′, 20″) ability to remove dissolved impurities from the fluid in addition to suspended solids. In some embodiments, the desired pressure differential is achieved and maintained through observation of the pressures measured in both the subchamber 23′ (e.g., through sensor 81) and the subchamber 23″ (e.g., through sensor 89), and subsequent adjustment of the rotational speed and thus the discharge pressure of the pump 50 and/or the pump 52 (e.g., via VFDs 86, 88, respectively).

In one specific example, when the measured pressure differential between the subchambers 23′, 23″ rises over a pre-determined value or range of values, the controller 82 directs the VFD 86 to decrease the rotational speed and thus the discharge pressure of the feed pump 50. Conversely, when the measured differential pressure between the subchambers 23′, 23″ falls below the pre-determined value of range of values, the controller 82 directs the VFD 86 to increase the rotational speed and thus the discharge pressure of the feed pump 50. The pre-determined value or range of values for the desired pressure differential is determined by a number of factors, including, for example, the type of fluid 3, the level or amount of impurities contained within fluid 3, or the specific gravity of fluid 3. The fine level of control provided by the VFD 86 allows flexibility in the way the feed pump 50 reacts to the measured pressure differential. The VFD 86 can cause the feed pump 50 to respond quickly to pressure changes, and to vary the pressure response based on the rate of change of the measured pressure differential.

Referring still to FIGS. 16 and 17, in some embodiments, controller 82 may adjust the discharge pressure of the feed pump 50 and/or the pump 52 based at least partially on the measurements obtained from the conductivity sensor 87 disposed on line 16. Such adjustment may take place either in addition to or in lieu of adjustments based on other measured values (e.g., pressure). In particular, for some applications, many of the dissolved impurities within the fluid comprise ions or ionic compounds (e.g., sodium chloride). Thus, during operation sensor 87 measures electrical properties (e.g., electrical conductivity) of the fluid in discharge line 16 in order to detect the level of dissolved impurities within the fluid to give an indication of the effectiveness of the cleaning process taking place within assembly 20 (e.g., by comparing the sensed conductivity to a known or predetermined value or range of values). The controller 82 may then adjust the discharge pressure of the pump 50 and/or the pump 52 (e.g., via the VFDs 86, 88, respectively) based at least partially on the output from the sensor 87 to optimize the pressure differential between the subchambers 23′, 23″ and thus facilitate fluid cavitation to remove such dissolved impurities.

Further, in some embodiments, controller 82 may adjust the discharge pressure of the pump 50 and/or the pump 52 based at least partially on the measurements obtained from the acoustic sensor 83 disposed on vessel 22. Such adjustment may take place either in addition to or in lieu of adjustments based on other measured values (e.g., pressure, conductivity). In particular, when cavitation is occurring within chamber 23 small bubbles form and collapse in the manner previously described, thereby resulting in the formation of a pressure wave. These generated pressure waves have a determinable acoustic frequency ω_{R}. Thus, in at least some embodiments, the controller 82 is configured to measure an audio signal in the frequency range for fluid in subchamber 23″ via the sensor 83 during operation and compare it to a pre-determined value or range of values. The pre-determined value or range of values for the frequency is determined based on the expected acoustic resonant frequencies ω_{R} which result when the fluid cavitation is occurring. In some embodiments, the anticipated frequency of vibration ω_{R} in which cavitation is occurring within chamber 23 may be between 200 Hz and 20,000 Hz. The controller 82 may then adjust the discharge pressure of the pump 50 and/or the pump 52 (e.g., via the VFDs 86, 88, respectively) based at least partially on the output of the sensor 83 to optimize the pressure differential between the subchambers 23′, 23″ and thus maintain fluid cavitation to remove any dissolved impurities. As previously discussed, the discharge pressure response of the pumps 50, 52 is immediate, variable, and continuous as needed based on the functionality of the VFDs 86, 88.

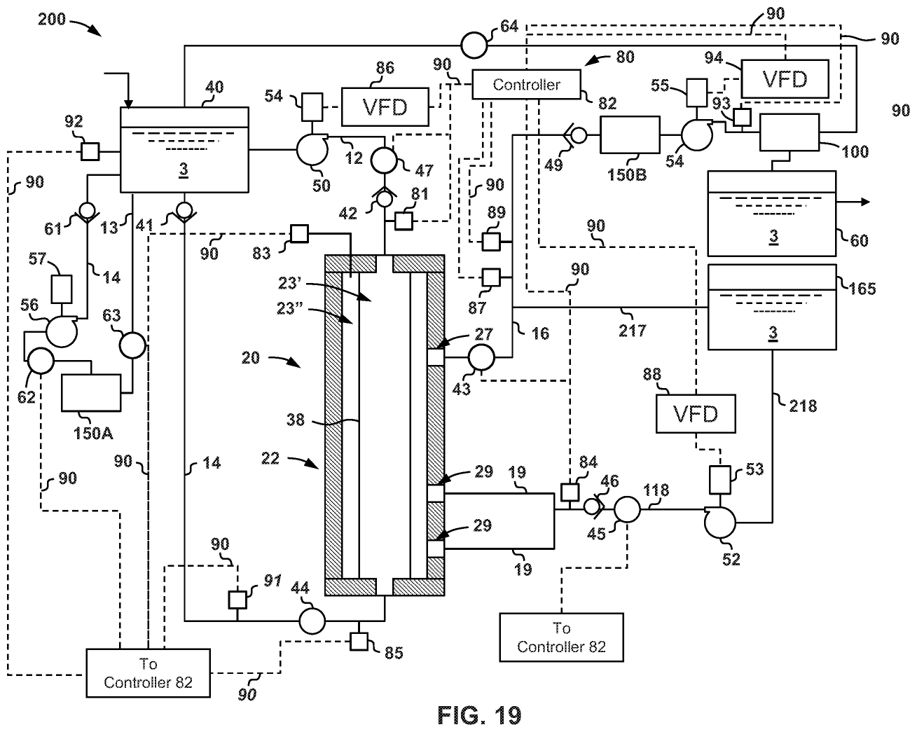

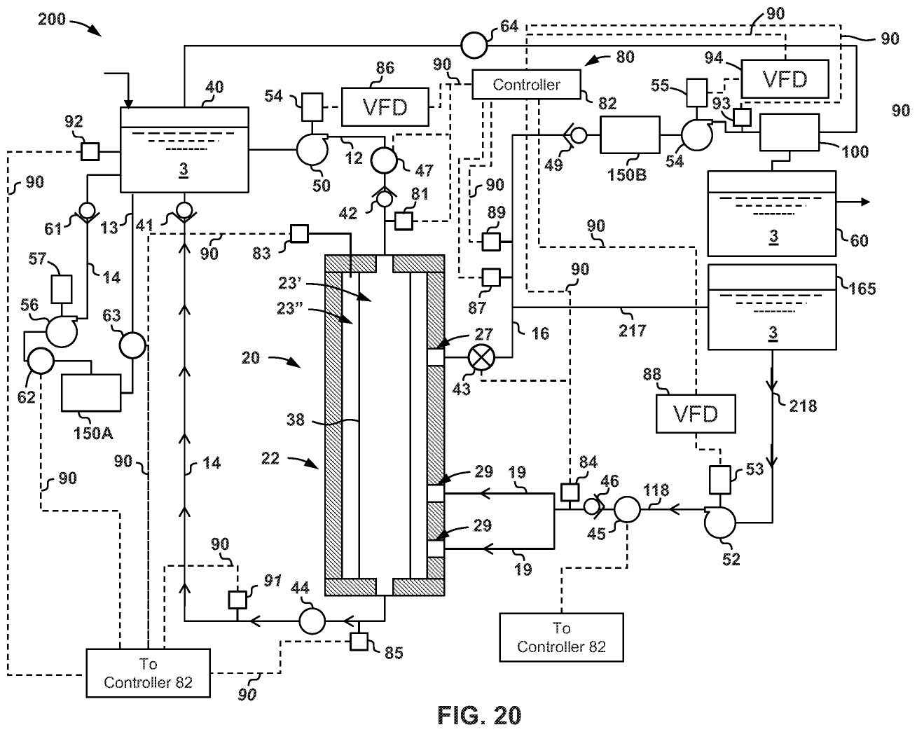

Referring to FIGS. 19 and 20, another embodiment of a filter system 200 is shown. Filter system 200 includes many similar components to the filter system 10. As a result, like reference numerals are used for like components and features, and shared components may not be called out or discussed in detail with reference to FIGS. 19 and 20 but the same description with regard to system 10 applies equally to system 200 unless otherwise noted. Instead, the focus of the discussion will be on variations or differences in the filter system 200 over the filter system 10. In general, the system 200 is the same as system 10, previously described; however, system 200 does not include a recirculation line 21. Instead, the filter system 200 includes an additional prime tank 165 that is coupled to discharge line 16 through a branch 217. Prime tank 165 is also coupled to pump 52 through a priming line 218. Line 218 is further coupled to the pair of injection lines 19, previously described. Further, as shown in FIG. 19, the valves 46 and 45 are also disposed along line 218. Referring specifically to FIG. 20, the operation of system 200 is substantially the same as described above for system 10; however, when system 200 enters a reject state of operation, fluid 3 flows from prime tank 165 (instead of clean water tank 60), through line 218, and into lines 19 to clean or sweep the screen 38 as previously described. In addition, it should be appreciated that in other embodiments, branch 217 may extend from discharge line 16 downstream of solids collector 150A or may extend from either lines 16, 18 downstream of polisher 100.

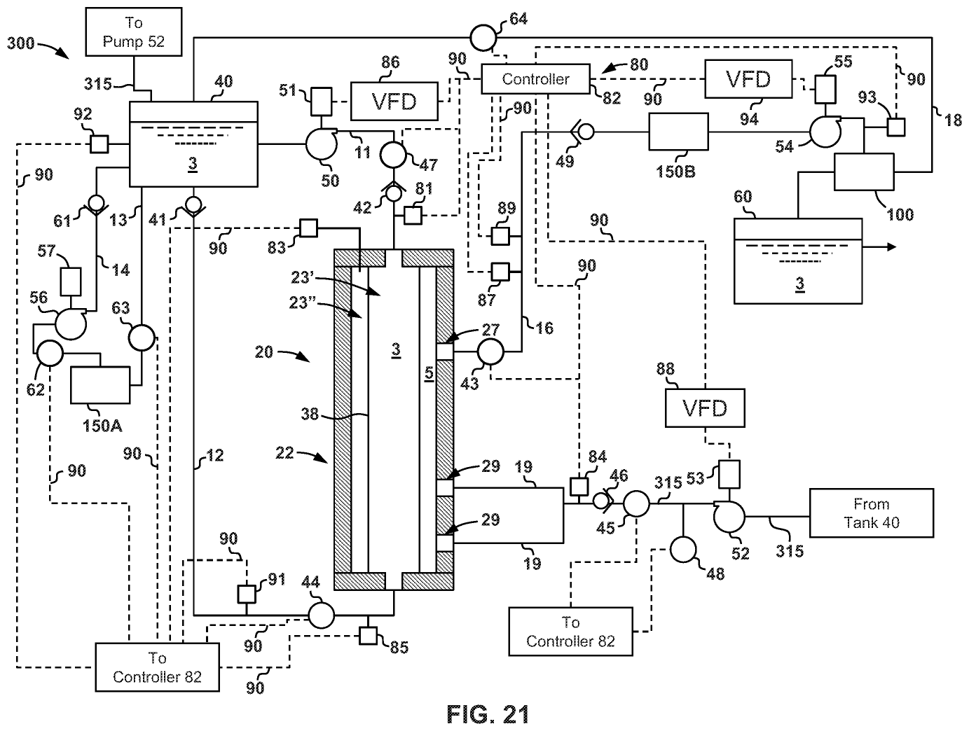

Referring now to FIG. 21, another embodiment of a filter system 300 is shown. Filter system 300 includes many similar components to the filter system 10. As a result, like reference numerals are used for like components and features, and shared components may not be called out or discussed in detail with reference to FIG. 21 but the same description with regard to system 10 applies equally to system 300 unless otherwise noted. Instead, the focus of the discussion will be on variations or differences in the filter system 300 over the filter system 10. In general, the system 300 is the same as system 10, previously described; however, system 300 does not include either return line 15, or recirculation line 21 coupled to finish tank 60. Rather, system 300 includes a recirculation line 315 extending from start tank 40 that is coupled to pump 52. Recirculation line 315 is coupled to injection lines 19, previously described. Therefore, during operations, when system 300 is operated in a reject state, fluid 3 is pumped from tank 40 via pump 52 through line 315 and into lines 19 to clean or sweep the screen 38 as previously described.

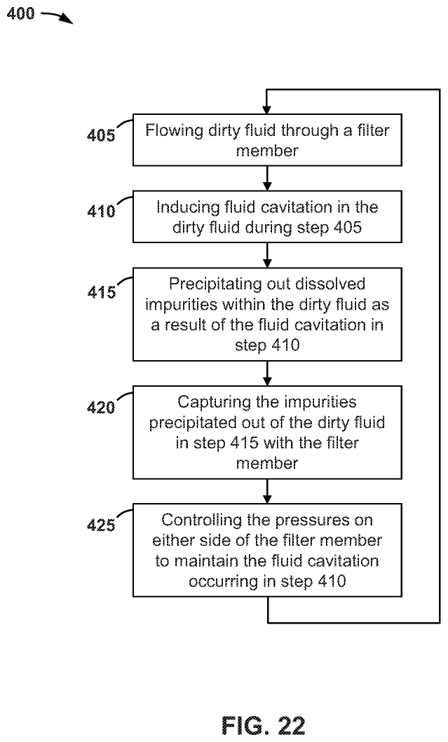

Referring now to FIG. 22 wherein a method 400 for filtering a fluid containing some amount of dissolved and/or suspended impurities (e.g., fluid 3) is shown. In order to provide context and enhance clarity, method 400 will be explained with reference to components and features of filter system 10, previously described; however, it should be appreciated that method 400 may be carried out with any suitable system other than system 10 (e.g., systems 200, 300 or some other suitable system).

Method 400 begins by flowing dirty fluid (e.g., fluid 3) through a filter member in step 405. The filter member may be any suitable screen (e.g., screen 38, 38′, etc.) membrane or other suitable member for filtering impurities from a fluid. As fluid is being routed through the filter member in step 405, fluid cavitation is induced in step 410 such that bubbles are formed and then subsequently collapse in the manner described above. As a result of the cavitation occurring in step 410, at least a portion of the dissolved impurities within the dirty fluid are precipitated out of the dirty fluid in step 415. In some embodiments, dissolved solids are precipitated out of the dirty fluid in step 415 in the same manner as previously described above for system 10. The method 400 next includes capturing the impurities precipitated out of the dirty fluid in step 415 with the filter member in step 420. Finally, the method 400 includes controlling the pressures (e.g., through pumps 50, 52, motors 54, 53, and VFDs 86, 88) on either side of the filter member (e.g., in subchambers 23′, 23″) in step 425 to facilitate and maintain the fluid cavitation occurring in step 410.

In some embodiments, the dirty fluid is salt water (e.g., such as sea water) and the dissolved impurities comprise, among other things, sodium chloride (NaCl). Thus, in these embodiments, when cavitation occurs in step 405, the kinetic energy released as a result of the collapse of bubbles formed during cavitation precipitates the sodium (Na) and chloride (Cl) molecules out of the solution in the manner previously described above such that crystalized sodium chloride NaCl forms which is then captured with the filter member in step 420.

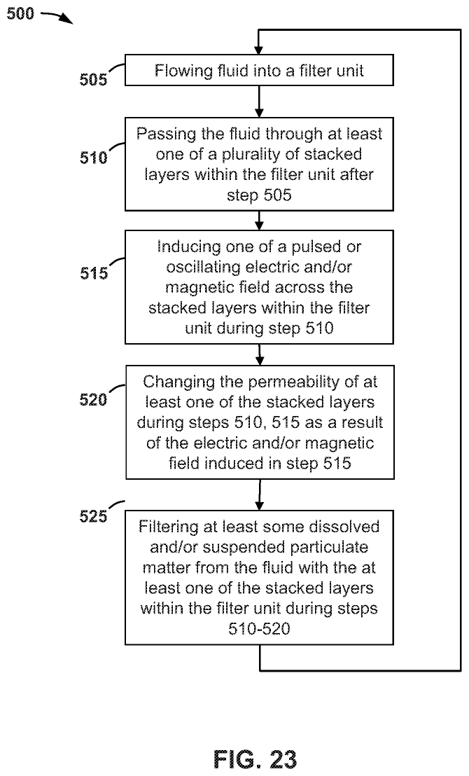

Referring now to FIG. 23 wherein a method 500 for filtering a fluid containing some amount of dissolved and/or suspended impurities (e.g., fluid 3) is shown. In order to provide context and enhance clarity, method 500 will be explained with reference to components and features of filter system 10, previously described; however, it should be appreciated that method 500 may be carried out with any suitable system other than system 10 (e.g., systems 200, 300 or some other suitable system).

Method 500 begins by flowing a fluid (e.g., fluid 3) into a filter unit in step 505. The filter unit (e.g., filter unit 160 of polisher 100) may be any suitable membrane(s) or other suitable stacked filter material (or combination of materials) (e.g., layers 162, 164, 166) for filtering impurities from a fluid. After entering the filter unit in step 505, the fluid is then passed or flowed across at least one of a plurality of stacked layers (e.g., layers 162, 164, 166) within the filter unit at step 510. As the fluid is passing through the at least one of the plurality of stacked layers in the filter unit, method 500 also includes inducing one of an oscillating or pulsed electric or magnetic field across the stacked layers of the filter unit at step 515. At the same time, method 500 includes changing the permeability of at least one of the stacked layers within the filter unit while flowing or passing the fluid across the at least one of the stacked layers and as a result of the electric or magnetic field induced at step 515. Finally, method 500 includes filtering at least some dissolved and/or suspended particulate matter from the fluid with the at least one of the stacked layers within the filter unit at step 525 and simultaneously with steps 510-520.

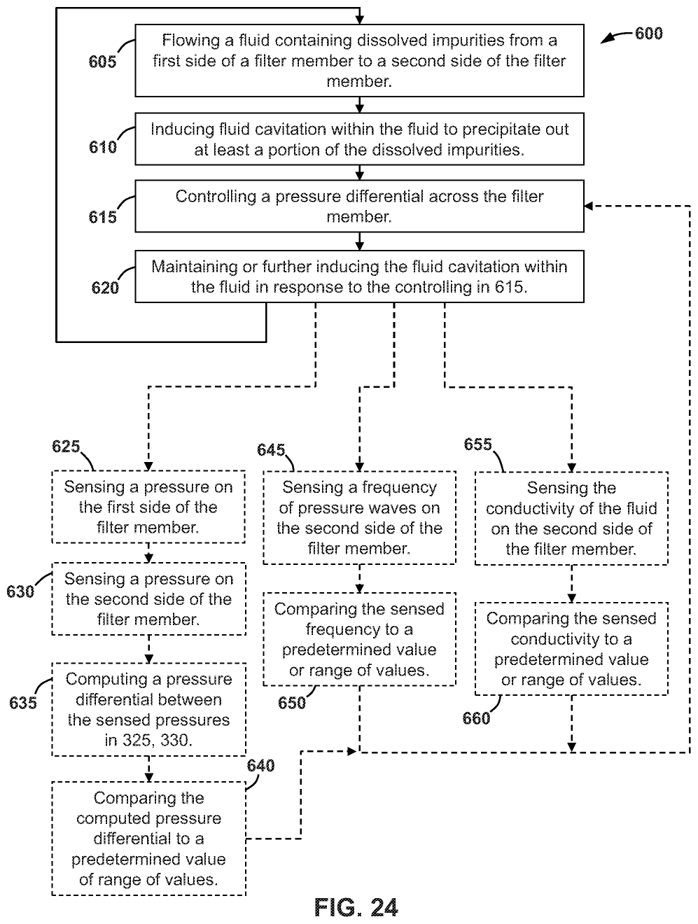

Referring now to FIG. 24 wherein another method 600 for filtering a fluid containing some amount of dissolved impurities (e.g., fluid 3) is shown. In order to provide context and enhance clarity, method 600 will be explained with reference to components and features of filter system 10, previously described; however, it should be appreciated that method 600 may be carried out with any suitable system other than system 10 (e.g., systems 200, 300 or some other suitable system).

Method 600 begins by flowing a fluid from a first side (e.g., subchamber 23′) of a filter member to a second side (e.g., subchamber 23″) of the filter member in step 605. As with method 400, previously described, the filter member may be any suitable screen (e.g., screen 38, 38′, etc.) membrane or other suitable member for filtering impurities from a fluid. In addition, in some embodiments, the fluid contains suspended and/or dissolved impurities (e.g., NaCl). The method 600 also includes inducing fluid cavitation within the fluid to precipitate out at least a portion of the dissolved impurities in step 610. In some embodiments, dissolved solids are precipitated out of the fluid in step 610 in the same manner as previously described above for system 10. The method 600 further includes controlling a pressure differential across the filter member (e.g., through pumps 50, 52, motors 54, 53, and VFDs 86, 88), between the first and second sides (e.g., in subchambers 23′. 23″) in step 615, and maintaining or further inducing the fluid cavitation within the fluid in step 620 in response to the controlling of step 615. Thereafter, in some embodiments, method 600 reinitiates step 605.

Method 600 also includes several optional steps of which all or some may be performed in addition to steps 605-620, previously described. In particular, in some embodiments, method 600 includes the optional step of sensing a pressure on the first side (e.g., subchamber 23′) of the filter member in step 625 and sensing a pressure on the second side (e.g., subchamber 23″) of the filter member in step 630. Thereafter, step 635 includes computing a pressure differential between the sensed pressures in steps 625, 630. Finally, method 600 includes comparing the computed pressure differential of step 635 to a predetermined value or range of values in step 640 (e.g., with controller 82) such that the comparison may be used to at least partially affect the controlling of step 615.

In some embodiments, method 600 also includes the optional step of sensing a frequency of pressure waves on the second side (e.g., subchamber 23″) of the filter member (e.g., with sensor 83) in step 645. Thereafter, step 650 includes comparing the sensed frequency in step 645 to a predetermined value or range of values such that the comparison may be used to at least partially affect the controlling of step 615 (e.g., with controller 82).

In still some embodiments, method 600 includes the optional step of sensing the conductivity of the fluid on the second side of the filter member (e.g., with conductivity sensor 87) in step 655. Thereafter, step 660 includes comparing the sensed conductivity in step 655 with a predetermined value or range of values such that the comparison may be used to at least partially affect the controlling in step 615 (e.g., with controller 82).

Through use of a filter system (e.g., system 10, 200, 300) according to the embodiments disclosed herein, the filtration of fluid (e.g., used flowback frac water, salt water, fluid produced from a subterranean mineral mine) is enhanced, thereby facilitating more effective removal of both suspended solids and other dissolved impurities. Further, through use of a filter system according to the embodiments disclosed herein, more effective filtration of a fluid is achieved by inducing and maintaining cavitation in the filtered fluid during the filtering process by a control system (e.g., system 80) that closely manages and manipulates differential pressures in the system. Still further, through use of a filter system according to the embodiments disclosed herein, the induction of an electric and/or magnetic field may controllably vary the permeability of at least one filter unit (e.g., filter unit 160) to allow for higher flow rates at lower pressures through at least a portion of the filter system.

While embodiments disclosed herein have shown only a single filter assembly 20 (or assembly 20′) included within system 10 (or system 100), it should be appreciated that in other embodiments, more than one assembly 20 (or assembly 20′) may be included either in parallel, in series, or in some combination thereof within system 10 or 100 while still complying with the principles disclosed herein. In addition, while embodiments disclosed herein have included two lines 19, it should be appreciated that other embodiments may have more or less than two lines 19. Further, while embodiments disclosed herein have described the controller 82 as being a single component, it should be appreciated that in other embodiments, the controller 82 may comprise multiples components and may comprise multiple individual control units or control circuits which correspond to different components and features of the filter system (e.g., system 10, 100). Still further, while embodiments disclosed herein have described the use of pressure, flow rate, acoustic, and conductivity sensors within the systems 10, 100, it should be appreciated that in other embodiments, other sensors may be utilized with the system 10, 100 which measure various other values and parameters while still complying with the principles disclosed herein. For example, in some embodiments, temperature sensors may be disposed along the various lines 12, 14, 16, 17, 18, 117. Additionally, in some embodiments level sensors may be included on the tanks 40, 60, 165 to provide a measure of the level of fluids within tanks 40, 60, 165 during operation. Further, while embodiments disclosed herein have shown and described only a single system 10, 100, it should be appreciated that in some embodiments, multiple systems 10 or 100 may be coupled in series, in parallel, or in some combination thereof in order to effect cleaning of fluids during operation. Still further, while embodiments disclosed herein have described a filter system (e.g., system 10, 100) being used to filter particles from fluid used in the oil and gas industry during drilling or completion of earthen wellbores, it should be appreciated that in other embodiments, the previously described filtering systems may be used in connection with any suitable processes or industry which requires the filtration of particles from fluids. For example, some embodiments of filter systems 10 and/or 100, previously described, may be used to filter fluids such as industrial waste waters, reclaimed waters from food processing, and sea water while still complying with the principles disclosed herein. While only the filter assembly 20′ shown in FIG. 3 has been shown and described to include a mounting device (e.g., plate 73) it should be appreciated that any embodiment of assemblies 20 and 20″ may also include plate 73 or some other suitable mounting device while still complying with the principle disclosed herein. Further, it should be appreciated that in some embodiments, VFDs 86, 88, may be replaced with any suitable throttling or adjustment assembly configured to adjust the output rotational speed of the motors 54, 74 to control the pressure differential between the subchambers 23′, 23″ while still complying with the principles disclosed herein. For example, in some embodiments, motors 54, 74 are hydraulically driven and VFDs 86, 88 are replaced with throttling valves which control the flow of hydraulic fluid through motors 54, 74 thus controlling the output rotational speed thereof.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosed subject matter. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A polisher for filtering a fluid, the polisher comprising:
a body defining a cavity;
a filter unit disposed within the cavity;
a plurality of transducers coupled to the body, wherein the plurality of transducers are configured to provide at least one of an electric field or a magnetic field across the filter unit, wherein the at least one of the electric field or the magnet field from the plurality of transducers intersect in the filter unit.

2. The polisher of claim 1, further comprising:
an inlet;
a first outlet; and
a second outlet;
wherein the filter unit comprises a plurality of cylindrical layers concentrically arranged about a central axis;
wherein the first outlet is configured to receive fluid that has completely passed radially across a radially innermost layer of the filter unit; and
wherein the second outlet is configured to receive fluid that has not completely passed radially across the radially innermost layers of the filter unit.

3. The polisher of claim 2, wherein the plurality of cylindrical layers of the filter unit comprises:
at least one layer of a metallic spacer material;
at least one layer of a felt filter membrane; and
at least one layer of a permeable material configured to allow fluid to flow axially therethrough with respect to the central axis.

4. The polisher of claim 2, further comprising:
a first channel fluidly coupled to the inlet;
a second channel fluidly coupled to the second outlet;
a core tube extending coaxially through the filter unit within the cavity;
wherein the core tube includes:
an open end that forms the first outlet; and
one or more ports in communication with the cavity.

5. The polisher of claim 4, further comprising a first diffuser disposed in the first channel, axially between the inlet and the cavity;
wherein the first diffuser includes a plurality of flow ports extending axially therethrough.

6. The polisher of claim 5, further comprising a second diffuser disposed within the second channel, axially between the cavity and the second outlet;
wherein the second diffuser includes a plurality of flow ports extending axially therethrough.

7-8. (canceled)

9. A system for filtering fluid, the system comprising:
a filter assembly configured to receive a fluid, wherein the filter assembly comprises:
a filter screen disposed within a vessel, the screen dividing the vessel into a first subchamber and a second subchamber;
wherein the vessel comprises an inlet, an outlet, and a fluid flow path extending from the inlet, into the first subchamber, across the filter screen, and into the second subchamber; and
a polisher downstream of the filter assembly, wherein the polisher comprises:
a body defining a cavity;
a filter unit disposed within the cavity; and
a plurality of transducers positioned at a first angle relative to each other on the body.

10. The system of claim 9, further comprising a first pump fluidly coupled to the filter assembly, the first pump having a discharge pressure;
a controller electrically coupled to the first pump, wherein the controller is configured to adjust the discharge pressure of the first pump to induce or maintain cavitation within the fluid as the fluid flows across the filter screen from the first subchamber to the second subchamber.

11. The system of claim 10, wherein the polisher further comprises:
an inlet;
a first outlet; and
a second outlet;
wherein the filter unit comprises a plurality of cylindrical layers concentrically arranged about a central axis;
wherein the first outlet of the polisher is configured to receive fluid that has completely passed radially across a radially innermost layer of the filter unit; and
wherein the second outlet of the polisher is configured to receive fluid that has not completely passed radially across the radially innermost layer of the filter unit

12. (canceled)

13. The system of claim 11, wherein the polisher further comprises:
a first channel fluidly coupled to the inlet of the polisher;
a second channel fluidly coupled to the second outlet of the polisher;
a core tube extending coaxially through the filter unit within the cavity;
wherein the core tube includes:
an open end that forms the first outlet of the polisher; and
one or more ports in communication with the cavity.

14-17. (canceled)

18. The system of claim 11, further comprising a start tank fluidly coupled to the inlet of the filter assembly;
wherein the second outlet of the polisher is fluidly coupled to the start tank.

19. The system of claim 18, further comprising:
a solids rejection line extending from the start tank;
a solids collector coupled to the solids rejection line, wherein the solids collector comprises:
a solids collector body defining an inner chamber;
a filter membrane disposed within the inner chamber, wherein the filter membrane separates the inner chamber into a first solids collector subchamber and a second solids collector subchamber;
a solids collector inlet in fluid communication with the first solids collector subchamber; and
a solids collector outlet in fluid communication with the second solids collector subchamber; and
a tank return line coupled to each of the solids collector outlet and the start tank.

20. The system of claim 19, further comprising a second pump disposed along the tank return line and configured to induce fluid to flow from the solids collector outlet to the start tank.

21. The system of claim 9, further comprising:
a solids collector fluidly disposed between the filter assembly and the polisher;
wherein the solids collector comprises:
a solids collector body defining an inner chamber;
a filter membrane disposed within the inner chamber, wherein the filter membrane separates the inner chamber into a first solids collector subchamber and a second solids collector subchamber;
a solids collector inlet in fluid communication with the first solids collector subchamber; and
a solids collector outlet in fluid communication with the second solids collector subchamber.

22. A system for filtering fluid, the system comprising:
a start tank;
a finish tank; and
a polisher comprising:
an inlet;
a first outlet fluidly coupled to the finish tank;
a second outlet fluidly coupled to the start tank;
a filter unit; and
one or more transducer coupled to an outer surface of the polisher and configured to induce at least one of an electric field or a magnetic field across the filter unit;
wherein the start tank is fluidly coupled to the inlet of the polisher.

23. The system of claim 22, wherein the filter unit comprises a plurality of cylindrical layers concentrically arranged about a central axis;
wherein the first outlet is configured to receive fluid that has completely passed radially across a radially innermost layer of the filter unit; and
wherein the second outlet is configured to receive fluid that has not completely passed radially across the radially innermost layer of the filter unit.

24. The system of claim 23, further comprising:
a solids rejection line extending from the start tank;
a solids collector coupled to the solids rejection line, wherein the solids collector comprises:
a solids collector body defining an inner chamber;
a filter membrane disposed within the inner chamber, wherein the filter membrane separates the inner chamber into a first subchamber and a second subchamber;
an inlet in fluid communication with the first subchamber; and
an outlet in fluid communication with the second subchamber; and
a tank return line coupled to each of the outlet of the solids collector and the start tank.

25. The system of claim 24, further comprising a pump disposed along the tank return line and configured to induce fluid to flow from the outlet of the solids collector to the start tank.

26-31. (canceled)

32. A method for filtering fluid, the method comprising:
routing a fluid into a cavity defined within a polisher;
flowing a first portion of the fluid across a filter unit within the cavity and toward a first outlet of the polisher;
providing intersecting electric fields or magnetic fields across the filter unit while flowing the first portion of the fluid across the filter unit.

33. The method of claim 32, further comprising changing the permeability of at least a portion of the filter unit as a result of the providing intersecting electric fields or magnetic fields.

34. The method of claim 33, further comprising flowing a second portion of the fluid through the cavity and through a second outlet of the polisher.

35. The method of claim 34, further comprising:
flowing the second portion of the fluid to a start tank after flowing the second portion of the fluid through the second outlet;
increasing the conductivity within the start tank as a result of the flowing the second portion of the fluid to the start tank; and
precipitating dissolved impurities from the second portion of the fluid in the start tank as a result of the increasing the conductivity.

36. The method of claim 35, further comprising receiving the fluid in the start tank from a source before routing the fluid into the cavity defined within the polisher.

37. The method of claim 36, further comprising:
flowing the second portion of the fluid from the start tank to a solids collector; and
capturing impurities with the solids collector that were precipitated out of the second portion of the fluid as a result of increasing the conductivity within the start tank.

38. The method of claim 36, further comprising flowing the fluid across a filter screen within a filter assembly after receiving the fluid in the start tank from the source and before routing the fluid into the cavity defined within the polisher.

39. The method of claim 38, further comprising inducing cavitation within the fluid as the fluid flows across the filter screen.

40. (canceled)
